(19) United States
(12) Patent Application Publication
(10) Pub. No.: US 2013/0083273 A1
(43) Pub. Date: Apr. 4, 2013

(54) SURFACE FILM FOR IMAGE DISPLAY DEVICE, POLARIZING PLATE, AND IMAGE DISPLAY DEVICE

(71) Applicant: FUJIFILM CORPORATION, Tokyo (JP)

(72) Inventors: Kenichi FUKUDA, Kanagawa (JP); Miho ASAHI, Kanagawa (JP)

(73) Assignee: FUJIFILM CORPORATION, Tokyo (JP)

(21) Appl. No.: 13/630,336

(22) Filed: Sep. 28, 2012

(30) Foreign Application Priority Data
Sep. 30, 2011 (JP) 2011-218512

(51) Int. Cl. G02F 1/1335

(52) U.S. Cl. 349/96; 349/193

(57) ABSTRACT

There is provided an optical film to be used as a surface film for image display device, which comprises an optically anisotropic layer and a hard coat layer in this order on one surface of a transparent support, the optically anisotropic layer and the hard coat layer being brought into direct contact with each other, wherein the optically anisotropic layer is formed of an optically anisotropic layer forming composition containing a liquid crystalline compound having an unsaturated double bond; the hard coat layer is formed of a hard coat layer forming composition containing a compound having an unsaturated double bond and has a film thickness of from 3 to 30 μm; and the optical film has an in-plane retardation of from 80 to 200 nm at a wavelength of 550 nm.

### CROSS-REFERENCE TO RELATED APPLICATIONS

This application claims priority from Japanese Patent Application No. 2011-218512, filed Sep. 30, 2011, the contents of all of which are hereby incorporated by reference in their entirety.

### BACKGROUND OF THE INVENTION

1. Field of the Invention

The present invention relates to an optical film to be used as a surface film for image display device, which comprises an optically anisotropic layer and a hard coat layer in this order on one surface of a transparent support, a polarizing plate having this optical film, and an image display device. In particular, the invention relates to an optical film which is suitably used as a surface film for liquid crystal display device, a polarizing plate containing this optical film as a protective film, and an image display device having this optical film disposed on a surface thereof such that the foregoing hard coat layer is located on the viewing side.

2. Description of the Related Art

A liquid crystal display device (LCD) is widely used because of thinness, light weight, and low electric power consumption. The liquid crystal display device includes a liquid crystal cell and a polarizing plate. In general, the polarizing plate is composed of a protective film and a polarizing film, and it is obtained by dyeing the polarizing film made of a polyvinyl alcohol film with iodine, stretching the dyed polarizing film, and then laminating the protective film on the both surfaces thereof. In a transmission type liquid crystal display device, in general, this polarizing plate is installed on the both sides of a liquid crystal cell, and furthermore, one or more optically compensatory films (retardation films) are disposed inside (on the liquid crystal cell side) the two polarizing plates. In addition, there may be the case where the optically compensatory film is used as the foregoing protective film. As the optically compensatory film, for example, those comprising a base material film (transparent support) having thereon an optically anisotropic layer in which a discotic liquid crystalline compound is fixed while keeping its alignment state, are widely used.

In recent years, for the purpose of realizing high performance of a liquid crystal display device, development of a stereoscopic image display device using a transmission type liquid crystal display device is being advanced. For example, as a stereoscopic image display method, JP-A-2010-243705 describes a transmission type liquid crystal display device of field-sequential two eyes stereoscopic vision, which is based on a transmission type liquid crystal display device having a liquid crystal cell disposed inside two polarizing plates and in which a retardation film (λ/4 plate) having an in-plane retardation of λ/4 is disposed outside the polarizing plate on the viewing side such that a slow axis of the λ/4 plate and an absorption axis of the polarizing plate on the viewing side form an angle of 45°, thereby converting outgoing light into circularly polarized light.

As the retardation film having an in-plane retardation of λ/4, there are exemplified those using a stretched film and those having an optically anisotropic layer formed of a curable liquid crystalline compound on a transparent support.

Among them, since the stretched film is in general fabricated by being stretched in the length direction or in the width direction, a slow axis thereof is parallel or orthogonal to the length direction.

In the fabrication of a polarizing plate, in the case of sticking a retardation film and a polarizing film to each other, in view of production efficiency, the retardation film and the polarizing film are preferably stuck to each other in a roll-to-roll system.

On the other hand, in the liquid crystal display device, in general, a stretched film made of polyvinyl alcohol is used as a polarizing film, and an absorption axis of the polarizing film is parallel to the length direction.

Accordingly, in order to stick the retardation film having the slow axis in the direction of 45° against the polarizing axis and the polarizing film to each other in the roll-to-roll system, a roll-shaped film of the retardation film having the slow axis in the direction of 45° is needed, and thus, the stretched film is not suitable for sticking in the roll-to-roll system.

On the contrary, the retardation film having an optically anisotropic layer formed of a curable liquid crystalline compound is suitable for sticking in the roll-to-roll system because the direction of the slow axis can be freely changed by controlling the alignment direction of the liquid crystalline compound by a rubbing method or the like.

In JP-A-2007-155970, it is described that a λ/4 plate in a roll film form having a slow axis in the direction of 45° against the longitudinal direction in which a polymerizable rod-shaped liquid crystalline compound is aligned by using a triacetyl cellulose film as a transparent support is fabricated, to which is then stuck a polarizing film in a roll-to-roll system, whereby an elliptical polarizing plate can be fabricated. The thus-fabricated elliptical polarizing plate has a configuration of optically anisotropic layer/alignment film/transparent support/polarizing film/protective film, and a liquid crystal cell is disposed on the side of the optically anisotropic layer, whereas the protective film is disposed on the viewing side of a display device.

### SUMMARY OF THE INVENTION

According to investigations made by the present inventors, in the case of using the elliptical polarizing plate of the configuration described in JP-A-2007-155970 as the λ/4 plate in the transmission type liquid crystal display device of field-sequential two eyes stereoscopic vision of JP-A-2010-243705, the optically anisotropic layer is needed to be disposed on the viewing side of the display device, and the optically anisotropic layer is exposed to external light. Thus, it has been noted that when the optically anisotropic layer is exposed to external light, its retardation greatly changes. When the retardation changes, at the time of 3D image observation, a problem of crosstalk is caused, so that the image has double vision. Thus, such is an extremely serious problem.

In summary, it is necessary to develop an optical film capable of providing a polarizing plate which is able to freely control the slow axis direction while having a retardation, even when exposed to external light, is free from a change of the retardation value, and meets the requirement of thinness.

These are problems which have hitherto been unknown, and any suggestions on a dissolution method therefor have not been obtained by the related-art technologies.

As for these new problems, the present inventors made detailed investigations regarding causes thereof and the like. As a result, in such an optical film having the foregoing configuration, it has been noted that the matter that at the time of mounting in an image display device, when the optically anisotropic layer is exposed to external light and used over a long period of time, the material of the optically anisotropic layer is deteriorated, thereby causing a change of retardation, namely, light fastness of the optically anisotropic layer, is of a problem.

The optically anisotropic layer has been used as an optically compensatory film upon being laminated on a transparent support. However, in the related-art technologies, the optically compensatory film was not used as a surface film to be disposed on the surface of the image display device but disposed inside the surface film or the polarizing film. Thus, the optically compensatory film was protected by the surface film or the polarizing film and was not exposed to external light or the like. For that reason, in particular, the problem of light fastness is not of a problem in the related-art technologies, and it is a problem which is visualized first in the case of using the optically compensatory layer as a surface film as in the invention.

An object of the invention is to solve the foregoing problems and is concerned with a composite film having functions of a surface protective film and a retardation film. That is, the object of the invention is to provide an optical film which is high in productivity and high in surface hardness, is suppressed with respect to a change of retardation to be caused due to deterioration by light, is excellent in an image quality of an image display device having the optical film mounted therein, and is suitable for thinning of a polarizing plate. In addition, the invention is also concerned with a polarizing plate and an image display device, each having such an optical film mounted therein.

The present inventors made extensive and intensive investigations. As a result, it has been found that in a configuration of an optical film according to the invention (optically anisotropic layer made of a liquid crystalline compound having an unsaturated double bond/alignment film/transparent support), a change of retardation when exposed to external light (in particular, ultraviolet rays) from the side of the optically anisotropic layer is related to oxygen; and that the change of retardation can be greatly suppressed by blocking oxygen into the optically anisotropic layer.

Then, the present inventors have found that the change of retardation can be suppressed by laminating a hard coat layer having a film thickness of 3 μm or more on the optically anisotropic layer, thereby blocking oxygen going toward the optically anisotropic layer and further found that adhesion can be enhanced by forming a hard coat layer directly on the optically anisotropic layer, thereby allowing the optically anisotropic layer and the hard coat layer to form a covalent bond, leading to accomplishment of the invention.

Furthermore, the present inventors have found that if ultraviolet rays are irradiated on the optical film having a hard coat layer laminated thereon, the film is possibly colored yellow, and this is caused due to the fact that the liquid crystalline compound of the optically anisotropic layer is decomposed by ultraviolet rays through a quite different mechanism from the foregoing change of retardation. It has been found that as for this problem, by containing a trace amount of an ultraviolet ray absorber, especially an ultraviolet ray absorber having a polymerizable group, in the hard coat layer, the problem of coloration can also be solved while keeping hard coat properties.

The foregoing problems of the invention can be achieved by the following constitutions.
(1) An optical film to be used as a surface film for image display device, which comprises an optically anisotropic layer and a hard coat layer in this order on one surface of a transparent support, the optically anisotropic layer and the hard coat layer being brought into direct contact with each other, wherein

the optically anisotropic layer is formed of an optically anisotropic layer forming composition containing a liquid crystalline compound having an unsaturated double bond;

the hard coat layer is formed of a hard coat layer forming composition containing a compound having an unsaturated double bond and has a film thickness of from 3 to 30 μm; and

the optical film has an in-plane retardation of from 80 to 200 nm at a wavelength of 550 nm.
(2) The optical film according to (1) above,

wherein the hard coat layer forming composition further contains an ultraviolet ray absorber.
(3) The optical film according to (2) above,

wherein the ultraviolet ray absorber is an ultraviolet ray absorber having an unsaturated double bond.
(4) The optical film according to (2) or (3) above,

wherein a content of the ultraviolet ray absorber is from 1 to 5% by mass relative to all of the solids of the hard coat layer forming composition.
(5) The optical film according to any one of (1) to (4) above,

wherein the hard coat layer forming composition further contains a phosphine oxide based photopolymerization initiator.
(6) The optical film according to any one of (1) to (5) above,

wherein the liquid crystalline compound is a discotic liquid crystalline compound.
(7) The optical film according to (6) above,

wherein the liquid crystalline compound is a discotic liquid crystal compound of a 1,3,5-substituted benzene type.
(8) The optical film according to any one of (1) to (7) above,

wherein the optically anisotropic layer forming composition further contains a non-liquid crystalline compound having an unsaturated double bond.
(9) The optical film according to any one of (1) to (8) above,

wherein a retardation of the transparent support in the thickness direction thereof at a wavelength of 550 nm is from 20 to 100 nm.
(10) The optical film according to any one of (1) to (9) above,

wherein a low refractive index layer having a refractive index lower than that of the transparent support is provided on the hard coat layer.
(11) The optical film according to any one of (1) to (10) above, which is in a long roll form in which a slow axis of the in-plane retardation is present at from 5 to 85° in the clockwise or counterclockwise direction on the basis of the length direction.
(12) The optical film according to any one of (1) to (11) above, which is used as a surface film for liquid crystal display device.
(13) A polarizing plate comprising at least one protective film and a polarizing film,

wherein the at least one protective film is the optical film according to any one of (1) to (12) above, and the surface of the optical film on the transparent support side and the polarizing film are stuck to each other.
(14) An image display device comprising at least one of the optical film according to any one of (1) to (12) above or the polarizing plate according to (13) above.
(15) A liquid crystal display device comprising the optical film according to any one of (1) to (12) above, a polarizing film, and a liquid crystal cell in this order from the viewing side,

wherein the optical film is disposed in such a manner that the hard coat layer is located on the viewing side, whereas the transparent support is located on the polarizing film side.

According to the invention, it is possible to provide an optical film which is high in productivity, high in surface hardness, excellent in light fastness (suppressed in a change of retardation by light), and excellent in image quality of an image display device having the optical film mounted therein (excellent in optical compensation and free from crosstalk, etc.), is able to contribute to thinning of a polarizing plate and an image display device having the same mounted therein, and is suitable as a surface film for image display device.

Furthermore, the optical film according to the invention is able to suppress coloration while providing the foregoing characteristics.

The optical film according to the invention is suited for a stereoscopic image display device on the basis of a transmission type liquid crystal display device.

### DETAILED DESCRIPTION OF THE INVENTION

Modes for carrying out the invention are hereunder described in detail, but it should not be construed that the invention is limited thereto. Incidentally, in this specification, in the case where a numerical value represents a physical property value, a characteristic value, etc., the terms “from (numerical value 1) to (numerical value 2)” mean “(numerical value 1) or more and (numerical value 2) or less”.

The optical film according to the invention is an optical film to be used as a surface film for image display device, which comprises an optically anisotropic layer and a hard coat layer in this order on one surface of a transparent support, the optically anisotropic layer and the hard coat layer being brought into direct contact with each other, wherein the optically anisotropic layer is formed of an optically anisotropic layer forming composition containing a liquid crystalline compound having an unsaturated double bond; the hard coat layer is formed of a hard coat layer forming composition containing a compound having an unsaturated double bond and has a film thickness of from 3 to 30 μm; and the optical film has an in-plane retardation of from 80 to 200 nm at a wavelength of 550 nm.

Materials which are used for the optical film, the polarizing plate, and the image display device according to the invention, and manufacturing methods thereof are hereunder described in detail.

### [Transparent Support]

### [Material Quality of Transparent Support]

As a material for forming the transparent support according to the invention, polymers which are excellent in optical performance, transparency, mechanical strength, heat stability, moisture shielding properties, isotropy, and the like are preferable. It is meant by the term “transparency” as referred to in the invention that a transmittance of visible light is 60% or more, and the transmittance is preferably 80% or more, and especially preferably 90% or more. Examples of the polymer include polycarbonate based polymers, polyester based polymers such as polyethylene terephthalate and polyethylene naphthalate, acrylic polymers such as polymethyl methacrylate, and styrene based polymers such as polystyrene and an acrylonitrile/styrene copolymer (AS resin). In addition, examples thereof further include polyolefins such as polyethylene and polypropylene, polyolefin based polymers such as an ethylene/propylene copolymer, vinyl chloride based polymers, amide based polymers such as nylons and aromatic polyamides, imide based polymers, sulfone based polymers, polyether sulfone based polymers, polyetheretherketone based polymers, polyphenylene sulfide based polymers, vinylidene chloride polymers, vinyl alcohol based polymers, vinyl butyral based polymers, arylate based polymers, polyoxymethylene based polymers, epoxy based polymers, and polymers composed of a mixture of the foregoing polymers. In addition, the polymer film according to the invention can also be formed as a cured layer of an ultraviolet ray curable or thermosetting resin such as acrylic resins, urethane based resins, acrylic urethane based resins, epoxy based resins, and a silicone based resin.

In addition, as the material for forming the transparent support according to the invention, a thermoplastic norbornene based resin can be preferably used. Examples of the thermoplastic norbornene based resin include ZEONEX and ZEONOR, both of which are manufactured by Zeon Corporation; and ARTON, manufactured by JSR Corporation.

In addition, as the material for forming the transparent support according to the invention, a cellulose based polymer (especially preferably a cellulose acylate) represented by triacetyl cellulose which has hitherto been used as a transparent protective film of a polarizing plate can be preferably used. While the cellulose acylate is hereunder chiefly described in detail as an example of the transparent support according to the invention, it will be apparent that its technical matters are similarly applicable to other polymer films.

### [Degree of Substitution of Cellulose Acylate]

Next, the cellulose acylate according to the invention which is manufactured using the foregoing cellulose as a raw material is described. The cellulose acylate is one obtained by acylating the hydroxyl groups of cellulose, and any acyl groups including from an acetyl group having a carbon atom number of 2 to one having a carbon atom number of 22 can be used as a substituent thereof. In the cellulose acylate according to the invention, a degree of substitution on the hydroxyl groups of the cellulose is not particularly limited. However, the degree of substitution can be obtained through calculation after measuring a degree of bonding of acetic acid and/or a fatty acid having a carbon atom number of from 3 to 22, which substitutes on the hydroxyl groups of the cellulose. The measurement method can be carried out in conformity with ASTM D-817-91.

In the cellulose acylate according to the invention, the degree of substitution on the hydroxyl groups of the cellulose is not particularly limited. However, a degree of acyl substitution on the hydroxyl groups of the cellulose is preferably from 2.50 to 3.00. The degree of substitution is more preferably from 2.75 to 3.00, and still more preferably from 2.85 to 3.00.

As for acetic acid and/or a fatty acid having a carbon atom number of from 3 to 22, which substitutes on the hydroxyl groups of the cellulose, the acyl group having a carbon atom number of from 2 to 22 is not particularly limited and may be either an aliphatic group or an aromatic group, and it may be used solely or in admixture of two or more kinds thereof. Examples of the cellulose ester acylated therewith include alkyl carbonyl esters, alkenyl carbonyl esters, aromatic carbonyl esters, or aromatic alkyl carbonyl esters of cellulose. Each of those esters may further have a substituted group. Examples of the preferred acyl group which can be used include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a t-butanoyl group, a cyclohexanecarbonyl group, an oleoyl group, a benzoyl group, a naphthylcarbonyl group, and a cinnamoyl group. Of these, an acetyl group, a propionyl group, a butanoyl group, a dodecanoyl group, an octadecanoyl group, a t-butanoyl group, an oleoyl group, a benzoyl group, a naphthylcarbonyl group, and a cinnamoyl group are preferable, with an acetyl group, a propionyl group, and a butanoyl group being more preferable.

### [Degree of Polymerization of Cellulose Acylate]

A degree of polymerization of the cellulose acylate which is preferably used in the invention is from 180 to 700 in terms of a viscosity average degree of polymerization, and in cellulose acetate, it is more preferably from 180 to 550, still more preferably from 180 to 400, and especially preferably from 180 to 350.

### [Additives of Transparent Support]

To the transparent support according to the invention, various additives (for example, an optical anisotropy modifier, a wavelength dispersion modifier, a fine particle, a plasticizer, an ultraviolet ray inhibitor, a deterioration inhibitor, a release agent, etc.) can be added. These are hereunder described. In addition, in the case where the transparent support is a cellulose acylate film, the timing of addition thereof may be any timing in a dope fabrication step (fabrication step of a cellulose acylate solution). However, a step of adding the additives for preparation may be conducted in a final stage in the dope fabrication step.

### [Ultraviolet Ray Absorber]

The transparent support of the optical film according to the invention preferably contains an ultraviolet ray absorber (UV absorber). By containing an ultraviolet ray absorber in the transparent support, it is possible to impart ultraviolet ray absorption properties. By containing an ultraviolet ray absorber in the transparent support, it is possible to prevent the occurrence of yellowing of the support (which is, for example, observed as a reduction of a transmittance at a wavelength of 400 nm) to be caused due to exposure to ultraviolet rays contained in external light, or deterioration of the polarizing film to be caused due to external light. Specific examples of the UV absorber include compounds described in paragraphs [0059] to [0135] of JP-A-2006-199855.

A transmittance of the transparent support at 380 nm is preferably 50% or less, more preferably 20% or less, still more preferably 10% or less, and especially more preferably 5% or less.

### [Matting Agent Fine Particle]

To the transparent support according to the invention, a fine particle is preferably added as a matting agent. Examples of the fine particle which can be used include those made of silicon dioxide, titanium dioxide, aluminum oxide, zirconium oxide, calcium carbonate, talc, clay, sintered kaolin, sintered calcium silicate, hydrated calcium silicate, aluminum silicate, magnesium silicate, and calcium phosphate. As the fine particle, a fine particle containing silicon is preferable because of its low turbidity, and silicon dioxide is especially preferable. The fine particle of silicon dioxide preferably has a primary average particle diameter of 20 nm or less and an apparent specific gravity of 70 g/L or more. One having an average diameter of primary particle of as small as from 5 to 16 nm is more preferable because it can reduce a haze of the film. The apparent specific gravity is preferably from 90 to 200 g/L, and more preferably from 100 to 200 g/L. One with a larger apparent specific gravity is preferable because it is able to form a high-concentration dispersion liquid, resulting in improvements of the haze and the aggregate.

In general, such a fine particle forms a secondary particle having an average particle diameter of from 0.1 to 3.0 μm. Such a fine particle is present in the form of an aggregate of primary particles in the film, and it forms convexes of from 0.1 to 3.0 μm on the film surface. The secondary average particle diameter is preferably 0.2 μm or more and 1.5 μm or less, more preferably 0.4 μm or more and 1.2 μm or less, and most preferably 0.6 μm or more and 1.1 μm or less. The primary or secondary particle diameter is defined as follows. The particles in the film are observed by a scanning electron microscope, and a diameter of the circle circumscribing the particle is taken as the particle diameter. In addition, 200 particles are observed while changing the site. An average value thereof is taken as the average particle diameter. In addition, the concavo-convex state of the film surface can be measured by a method such as AFM.

As the fine particle of silicon dioxide, there can be used commercially available products such as AEROSIL R972, R972V, R974, R812, 200, 200V, 300, R202, OX50, and TT600 (all of which are manufactured by Nippon Aerosil Co., Ltd.). The fine particle of zirconium oxide is commercially available under trade names of AEROSIL R976 and R811 (both of which are manufactured by Nippon Aerosil Co., Ltd.), and these commercially available products are usable.

Of these, AEROSIL 200V and AEROSIL R972V are a fine particle of silicon dioxide having a primary average particle diameter of 20 nm or less and an apparent specific gravity of 70 g/L or more, and these are especially preferable because they have a large effect for decreasing a coefficient of friction while keeping the turbidity of the optical film low.

### [Compound Capable of Lowering Optical Anisotropy]

Specific examples of a compound capable of lowering optical anisotropy of the transparent support include compounds described in paragraphs [0035] to [0058] of JP-A-2006-199855, but it should not be construed that the invention is limited to these compounds.

### [Plasticizer, Deterioration Inhibitor, and Release Agent]

Other than the compound capable of lowering optical anisotropy, the UV absorber, and the matting agent, various additives (for example, a plasticizer, a deterioration inhibitor, a release agent, an infrared ray absorber, etc.) can be added according to an application, as described above. They may be either a solid or an oily substance. These materials are described in details on pages 16 to 22 of Journal of Technical Disclosure, No. 2001-1745, issued on Mar. 15, 2001 by Japan Institute of Invention and Innovation.

### [Knurling]

The transparent support according to the invention preferably has a knurling portion at a film edge of the transparent support for the purpose of suppressing generation of a black band or deformation of the film at the time of handling in a roll form even when the transparent support is a wide thin film. The knurling portion as referred to herein means a portion which is formed by imparting concaves and convexes at the edge in the width direction of the transparent long support to make it bulky and is preferably provided at the both edges. As for a method for imparting concaves and convexes as the knurling portion, the knurling portion can be formed by pressing a heated emboss roll onto the film. Since fine concaves and convexes are formed on the emboss roll, the unevenness can be formed on the film by pressing the emboss roll onto the film, thereby making the edge bulky. A height of the knurling portion according the invention refers to a height from the film surface to a top of the convex formed by embossing. The knurling portion can also be provided on both of the back and front surfaces of the transparent support, and 3 or more knurling portions can also be formed on one surface. The height of the knurling portion is preferably made higher by 1 μm or more than a film thickness of the whole of the optical functional layers including the optically anisotropic layer and the hard coat layer, and a width of one knurling portion is preferably in the range of from 5 mm to 30 mm. In the case of providing the knurling portion on both of the back and front surfaces of the film, the sum of the heights of the respective knurling portions may be made higher by at least 1 μm. By making the height higher by 1 μm or more, the effect for suppressing generation of a black band and deformation of the film is revealed. The height of the knurling portion is preferably made higher by a range of from 2 μm to 10 μm than the film thickness of the whole of the optically functional layers. By allowing the height to fall within this range, generation of a black band and deformation of the film can be prevented, and troubles, for example, deformation of the support to be caused due to winding slippage or bulge of the knurling portion, do not occur.

### [Optically Anisotropic Layer]

The optically anisotropic layer which the optical film according to the invention has is described. The optically anisotropic layer as referred to herein means a layer capable of generating a retardation in light which has passed through the layer. In the invention, the optically anisotropic layer is provided on one surface of the transparent support. The optically anisotropic layer is preferably a layer which when formed on the alignment film, generates a retardation and is preferably provided so as to come into contact with the alignment film provided on one surface of the transparent support. That is, the optically anisotropic layer is preferably laminated directly on the alignment film provided on one surface of the transparent support without allowing other layer to intervene therebetween.

In addition, the optically anisotropic layer according to the invention is one formed of a composition containing a liquid crystalline compound having an unsaturated double bond.

In the optically anisotropic layer according to the invention, though materials and manufacturing conditions can be selected in conformity with various applications, a λ/4 film using a polymerizable liquid crystalline compound is one preferred embodiment.

First of all, the measurement method of optical characteristics is described. In this specification, Re(λ) and Rth(λ) represent an in-plane retardation and a retardation in the thickness direction at a wavelength of λ, respectively. The Re(λ) is measured by making light having a wavelength of λ nm incident in the normal line direction of the film in KOBRA 21ADH or WR (manufactured by Oji Scientific Instruments). In selecting the measuring wavelength λ nm, the measurement can be conducted by manually exchanging a wavelength selective filter or converting a measured value with a program, etc. In the case where the film to be measured is expressed by a uniaxial or biaxial retardation index ellipsoid, the Rth(λ) is calculated in the following manner. The Rth(λ) is calculated by KOBRA 21ADH or WR on the basis of six measured Re(λ) values, an assumed value of the average refractive index, and an inputted film thickness. The retardation Re(λ) values are measured such that light having a wavelength of λ nm is made incident to the film from six directions tilted at up to 50° at intervals of 10° to the film normal line direction, using an in-plane slow axis (detected by KOBRA 21ADH or WR) as a tilt axis (rotation axis) (when the film has no slow axis, the arbitrary in-plane direction is used as the rotation axis). In the foregoing, when a retardation value measured using the in-plane slow axis as the rotation axis is zero at a certain tilt angle to the normal line direction, the positive sign of a retardation value at a tilt angle larger than the foregoing certain tilt angle is converted to a negative sign, and the negative retardation value is then used in the calculation by KOBRA 21ADH or WR. Incidentally, the Rth can also be calculated by the following expressions (A) and (III) on the basis of an assumed value of the average refractive index, an inputted thickness value (d), and two retardation values measured in two tilt directions, using the slow axis as the tilt axis (the rotation axis) (when the film has no slow axis, the arbitrary in-plane direction is used as the rotation axis).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Expression ( A )$$

Incidentally, the foregoing Re(θ) represents a retardation value in the direction tilted at an angle θ from the normal line direction. In addition, in the expression (A), nx represents a refractive index in the slow axis direction in the plane; ny represents a refractive index in the direction orthogonal to nx in the plane; and nz represents a refractive index in the direction orthogonal to nx and ny.

Rth=((nx+ny)/2−nz)×d Expression (III)

In the case where the film to be measured cannot be expressed in terms of a uniaxial or biaxial refractive index ellipsoid, and thus, does not have a so-called optic axis, the Rth(λ) is calculated in the following manner. The Rth(λ) is calculated by KOBRA 21ADH or WR on the basis of eleven measured Re(λ) values, an assumed value of the average refractive index, and an inputted film thickness value. The retardation Re(λ) values are measured such that light having a wavelength of λ nm is made incident to the film from eleven directions tilted at −50° to +50° at intervals of 10° to the film normal line direction, using an in-plane slow axis (detected by KOBRA 21ADH or WR) as a tilt axis (rotation axis). In addition, in the foregoing measurements, as the assumed values of the average refractive indices, those described in Polymer Handbook (JOHN WILEY & SONS, INC.) and catalogs of various optical films can be used. Unknown average refractive indices may be obtained by measurement using an Abbe refractometer. The average refractive indices of major optical film materials are as follows: cellulose acylate (1.48), cycloolefin polymer (1.52), polycarbonate (1.59), polymethyl methacrylate (1.49), and polystyrene (1.59). The above values of nx, ny, and nz are calculated by KOBRA 21ADH or WR from the inputted assumed average refractive index and film thickness value. Nz is further calculated from thus obtained nx, ny, and nz according to an expression: Nz=(nx−nz)/(nx−ny).

Incidentally, the Re(λ) and Rth(λ) used in the Examples of the present application were calculated according to the method where the film to be measured regards as a film expressed by a uniaxial or biaxial refractive index ellipsoid among the methods described above.

### [Retardation of Optically Anisotropic Layer]

An in-plane retardation Re(550) of the optically anisotropic layer according to the invention at a wavelength of 550 nm is preferably from 80 to 200 nm, more preferably from 90 to 180 nm, still more preferably from 100 to 170 nm, and especially preferably from 110 to 160 nm.

In addition, an in-plane retardation Re(550) of the optical film according to the invention at a wavelength of 550 nm is preferably from 80 to 200 nm, more preferably from 100 to 170 nm, and still more preferably from 110 to 160 nm.

By controlling the in-plane retardation Re(550) at a wavelength of 550 nm within the foregoing range, for example, when the optical film is mounted in a transmission type liquid crystal display device of field-sequential two eyes stereoscopic vision, front crosstalk or decrease in brightness can be suppressed. In particular, the effects are remarkable when a viewer views the display device with cocking his or her head.

A retardation Rth(550) of the optically anisotropic film according to the invention in the thickness direction thereof at a wavelength of 550 nm is preferably from −70 to 70 nm, more preferably from −60 to 60 nm, still more preferably from −50 to 50 nm, and especially preferably from −20 to 20 nm.

By controlling the Rth(550) within the foregoing range, when the optical film is mounted in a transmission type liquid crystal display device of field-sequential two eyes stereoscopic vision, crosstalk in the oblique direction or decrease in brightness can be suppressed.

The Nz (=Rth(550)/Re(550)+0.5) calculated from the foregoing Re(550) and Rth(550) at a wavelength of 550 nm is preferably from −0.50 to 1.50, more preferably from −0.10 to 1.10, still more preferably from 0.1 to 0.9, and especially preferably from 0.3 to 0.7.

### [Liquid Crystalline Compound Having an Unsaturated Double Bond]

The optically anisotropic layer according to the invention is formed of a liquid crystalline compound having an unsaturated double bond (hereinafter also referred to simply as “liquid crystalline compound”). The kind of the liquid crystalline compound to be used is not particularly limited. For example, an optically anisotropic layer obtained by forming a low-molecular weight liquid crystalline compound into the nematic alignment in a liquid crystal state and then fixing by means of photocrosslinking or thermal crosslinking, or an optically anisotropic layer obtained by forming a high-molecular weight liquid crystalline compound into the nematic alignment in a liquid crystal state and then cooling it to fix the alignment, can also be used. Incidentally, in the invention, even in the case where a liquid crystalline compound is used in the optically anisotropic layer, the optically anisotropic layer is a layer formed through fixation of the liquid crystalline compound by means of polymerization or the like, and therefore, after the layer is formed, it is no longer required to exhibit crystallinity. The polymerizable liquid crystalline compound may be either a polyfunctional polymerizable liquid crystalline compound or a monofunctional polymerizable liquid crystalline compound.

The liquid crystalline compound which is contained in the composition for forming the optically anisotropic layer (optically anisotropic layer forming composition) has an unsaturated double bond. In view of the fact that the liquid crystalline compound has an unsaturated double bond, the adhesion of the optically anisotropic layer to the hard coat layer or the alignment film adjacent thereto can be enhanced. The liquid crystalline compound preferably has a group containing an unsaturated double bond. As the group having an unsaturated double bond, there are preferably exemplified a (meth)acryloyl group, a vinyl group, a styryl group, and an allyl group. Of these, a (meth)acryloyl group and —C(O)OCH═CH₂ are more preferable, and a (meth)acryloyl group is still more preferable.

The liquid crystalline compound may be either a discotic liquid crystalline compound (also referred to as “disc-shaped liquid crystalline compound”) or a rod-shaped liquid crystalline compound. In the optical film according to the invention, in order to obtain favorable optical characteristics (in particular, the retardation in the thickness direction at a wavelength of 550 nm), a discotic liquid crystalline compound is more preferable.

In the optically anisotropic layer, a molecule of the liquid crystalline compound is preferably fixed in any alignment state of vertical alignment, horizontal alignment, hybrid alignment, and tilted alignment. In order to fabricate a retardation plate having symmetrical viewing angle dependence, it is preferable that a disc plane of the discotic liquid crystalline compound is substantially vertical to the film plane (optically anisotropic layer plane), or that a long axis of the rod-shaped liquid crystalline compound is substantially horizontal to the film plane (plane direction of the optically anisotropic layer). It is meant by the terms “discotic liquid crystalline compound is substantially vertical” as referred to herein that an average value of angles formed by the film plane (optically anisotropic layer plane) and the disc plane of the discotic liquid crystalline compound falls within the range of from 70° to 90°. The average value of angles is more preferably in the range of from 80° to 90°, and still more preferably in the range of from 85° to 90°. It is means by the terms “rod-shaped liquid crystalline compound is substantially horizontal” as referred to herein that an average value of angles formed by the film plane (optically anisotropic layer plane) and a director of the rod-shaped liquid crystalline compound falls within the range of from 0° to 20°. The average value of angles is more preferably in the range of from 0° to 10°, and still more preferably in the range of from 0° to 5°.

In the case of fabricating an optically compensatory film having asymmetric viewing angle dependence by subjecting a molecule of the liquid crystalline compound to hybrid alignment, an average tilt angle of the director of the liquid crystalline compound is preferably from 5 to 85°, more preferably from 10 to 80°, and still more preferably from 15 to 75°.

The optically anisotropic layer in the optical film according to the invention may be composed of only a single layer, or may be a laminate of two or more optically anisotropic layers.

The optically anisotropic layer can be formed by coating a support with a coating solution containing a liquid crystalline compound such as a rod-shaped liquid crystalline compound and a discotic liquid crystalline compound and, if desired, a polymerization initiator, an alignment controlling agent, and other additives as described later. The optically anisotropic layer is preferably formed by coating the coating solution on an alignment film formed on a support.

A range of the content of the liquid crystalline compound having an unsaturated double bond in the optically anisotropic layer forming composition is preferably 50% by mass or more, more preferably from 70 to 99% by mass, and still more preferably from 80 to 98% by mass, relative to all of the solids of the composition (in the case of a coating solution, the composition exclusive of an solvent). So far as the content of the liquid crystalline compound having an unsaturated double bond in the optically anisotropic layer forming composition falls within the foregoing range, a sufficient retardation can be revealed in a thin film.

In addition, a content of the compound having an unsaturated double bond (total sum of the content of the foregoing liquid crystalline compound having an unsaturated double bond and the content of a non-liquid crystalline compound having an unsaturated double bond as described layer) in the optically anisotropic layer forming composition is preferably 70% by mass or more, more preferably from 80 to 99% by mass, and still more preferably from 90 to 98% by mass, relative to all of the solids of the composition (in the case of a coating solution, the composition exclusive of an solvent). (In this specification, mass ratio is equal to weight ratio.) So far as the content of the compound having an unsaturated double bond in the optically anisotropic layer forming composition falls within the foregoing range, sufficient physical strength can be given to the optically anisotropic layer.

### [Discotic Liquid Crystalline Compound]

In the invention, it is preferable to use a discotic liquid crystalline compound for the formation of an optically anisotropic layer which the foregoing optical film has. The discotic liquid crystalline compound is described in various documents (for example, C. Destrade, et al., Mol. Crysr. Liq. Cryst., Vol. 71, page 111 (1981); Quarterly Review of Chemistry, No. 22, “Chemistry of Liquid Crystal”, Chapter 5 and Chapter 10, Section 2 (1994), edited by The Chemical Society of Japan; B. Kohne, et al., Angew. Chem. Soc. Chem. Comm., page 1794 (1985); and J. Zhang, et al., J. Am. Chem. Soc., Vol. 116, page 2655 (1994)). Polymerization of the discotic liquid crystalline compound is described in JP-A-8-27284.

Specific examples of the discotic liquid crystalline compound which can be preferably used in the invention include compounds described in paragraphs [0038] to [0069] of JP-A-2009-97002 (discotic liquid crystal compounds of a 1,3,5-substituted benzene type). In addition, examples of a triphenylene compound which is a discotic liquid crystalline compound with small wavelength dispersion include compounds described in paragraphs [0062] to [0067] of JP-A-2007-108732.

In the invention, an optically anisotropic layer formed of the foregoing discotic liquid crystal compound of a 1,3,5-substituted benzene type is especially preferable because coloration after a light fastness test is small.

As described above, in the case of forming an optically anisotropic layer using a discotic liquid crystalline compound, an average value of angles formed by the film plane (optically anisotropic layer plane) and the disc plane of the discotic liquid crystalline compound is preferably in the range of from 70° to 90°, more preferably in the range of from 80° to 90°, and still more preferably in the range of from 85° to 90°.

An optimum retardation required for the transparent support varies depending upon a material for forming the optically anisotropic layer. In the case where the optically anisotropic layer contains a discotic liquid crystalline compound, and the discotic liquid crystalline compound is aligned at the foregoing angle, a retardation Rth(550) of the transparent support in the thickness direction thereof at a wavelength of 550 nm is preferably from 20 to 100 nm, more preferably from 30 to 90 nm, and especially preferably from 40 to 80 nm. By controlling the Rth(550) of the transparent support within the foregoing range, the Rth(550) of the optical film can be controlled within the foregoing preferred range.

In addition, an in-plane retardation Re(550) of the transparent support at a wavelength of 550 nm is preferably from 0 to 10 nm, more preferably from 0 to 8 nm, and especially preferably from 0 to 6 nm.

When a cellulose acylate film is used as the transparent support, the foregoing preferred retardation in the thickness direction and in-plane retardation can be easily obtained. An embodiment using a cellulose acylate film as the transparent support and a discotic liquid crystalline compound in the optically anisotropic layer is especially preferable from the standpoint of obtaining the foregoing optical characteristics as the optical film.

### [Rod-Shaped Liquid Crystalline Compound]

In the invention, a rod-shaped liquid crystalline compound may be used in the optically anisotropic layer. Examples of the rod-shaped liquid crystalline compound which is preferably used include azomethines, azoxys, cyanobiphenyls, cyanophenyl esters, benzoic acid esters, cyclohexanecarboxylic acid phenyl esters, cyanophenyl cyclohexanes, cyano-substituted phenylpyrimidines, alkoxy-substituted phenylpyrimidines, phenyldioxanes, tolans, and alkenylcyclohexylbenzonitriles are preferably used. Not only the foregoing low-molecular weight liquid crystalline compounds but high-molecular weight liquid crystalline compounds can be used. It is more preferable to fix the alignment of the rod-shaped liquid crystalline compound by means of polymerization. A liquid crystalline compound having a partial structure capable of undergoing polymerization or a crosslinking reaction with active light, electron beams, heat, or the like can be suitably used. A number of such a partial structure is preferably from 1 to 6, and more preferably from 1 to 3. As a polymerizable rod-shaped liquid crystalline compound, compounds described in, for example, Makromol. Chem., Vol. 190, page 2255 (1989), Advanced Materials, Vol. 5, page 107 (1993), U.S. Pat. Nos. 4,683,327, 5,622,648 and 5,770,107, International Publications Nos. 95/22586, 95/24455, 97/00600, 98/23580 and 98/52905, JP-A-1-272551, J-A-6-16616, JP-A-7-110469, JP-A-11-80081, and JP-A-2001-328973 can be used.

As described above, the optimum retardation required for the transparent support varies depending upon a material for forming the optically anisotropic layer. In the case where the optically anisotropic layer contains a rod-shaped liquid crystalline compound, and the rod-shaped liquid crystalline compound is aligned at the foregoing angle, a retardation Rth(550) of the transparent support in the thickness direction thereof at a wavelength of 550 nm is preferably from −120 to 20 nm, more preferably from −100 to 10 nm, and especially preferably from −80 to −50 nm. By controlling the Rth(550) of the transparent support within the foregoing range, the Rth(550) of the optical film can be controlled within the foregoing preferred range.

In addition, an in-plane retardation Re(550) of the transparent support at a wavelength of 550 nm is preferably from 0 to 10 nm, more preferably from 0 to 8 nm, and especially preferably from 0 to 6 nm.

### [Vertical Alignment Accelerating Agent]

At the time of forming the optically anisotropic layer, in order to uniformly vertically align molecules of the liquid crystalline compound, it is preferable to use an alignment controlling agent capable of controlling the liquid crystalline compound in the vertical alignment on both the alignment film interface side and the air interface side. For achieving this purpose, it is preferable to form the optically anisotropic layer by using a composition containing a compound which exerts an action to vertically align the liquid crystalline compound on the alignment film due to an exclusion volume effect, an electrostatic effect, or a surface energy effect together with the liquid crystalline compound. In addition, as for the control of the alignment on the air interface side, it is preferable to form the optically anisotropic layer by using a composition containing a compound which is localized on the air interface side at the time of alignment of the liquid crystalline compound and exerts an action to vertically align the liquid crystalline compound due to an exclusion volume effect, an electrostatic effect, or a surface energy effect together with the liquid crystalline compound. As the compound (alignment film interface side vertical aligning agent) which accelerates vertical alignment of the molecules of the liquid crystalline compound on the alignment film interface side, a pyridinium derivative is suitably used. As the compound (air interface side vertical aligning agent) which accelerates the vertical alignment of the molecules of the liquid crystalline compound on the air interface side, a compound containing a fluoroaliphatic group which accelerates the localization of the compound on the air interface side and one or more hydrophilic groups selected from the group consisting of a carboxyl group (—COOH), a sulfo group (—SO₃H), a phosphonoxy group {—OP(═O)(OH)₂}, and salts thereof is suitably used. In addition, for example, in the case of preparing the liquid crystalline composition as a coating solution by blending such a compound, coating properties of the coating solution are improved, and the generation of unevenness or repelling is suppressed. The vertical aligning agent is hereunder described in detail.

### [Alignment Film Interface Side Vertical Aligning Agent]

As the alignment film interface side vertical aligning agent which can be used in the invention, a pyridinium derivative (pyridinium salt) is suitably used. Specific examples of such a pyridinium derivative include compounds described in paragraphs [0058] to [0061] of JP-A-2006-113500.

A content of the pyridinium derivative in the composition for forming the optically anisotropic layer varies depending upon an application thereof and is preferably from 0.005 to 8% by mass, and more preferably from 0.01 to 5% by mass in the composition (in the case of preparing the composition as a coating solution, the liquid crystalline composition exclusive of an solvent).

### [Air Interface Side Vertical Aligning Agent]

As the air interface side vertical aligning agent, the following fluorine based polymer (containing a repeating unit represented by the following general formula (II) as a partial structure) or a fluorine-containing compound represented by the following general formula (III) is suitably used.

First of all, the fluorine based polymer (containing a repeating unit represented by the general formula (II) as a partial structure) is described. As for the air interface side vertical aligning agent, the fluorine based polymer is preferably a copolymer containing a repeating unit derived from a fluoroaliphatic group-containing monomer and a repeating unit represented by the following general formula (II).

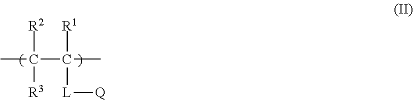

In the foregoing general formula (II), each of R¹, R², and R³ independently represents a hydrogen atom or a substituent; and L represents a divalent connecting group selected from the following group of connecting groups or a divalent connecting group formed from a combination of two or more members selected from the following group of connecting groups.

### (Group of Connecting Groups)

A single bond, —O—, —CO—, NR⁴— (R⁴ represents a hydrogen atom, an alkyl group, an aryl group, or an aralkyl group), —S—, —SO₂—, —P(═O)(OR⁵)— (R⁵ represents an alkyl group, an aryl group, or an aralkyl group), an alkylene group, and an arylene group.

Q represents a carboxyl group (—COOH) or a salt thereof, a sulfo group (—SO₃H) or a salt thereof, or a phosphonoxy group {—OP(═O)(OH)₂} or a salt thereof.

The fluorine based polymer which can be used in the invention is characterized by containing fluoroaliphatic group and one or more hydrophilic groups selected from the group consisting of a carboxyl group (—COOH), a sulfo group (—SO₃H), a phosphonoxy group {—OP(═O)(OH)₂}, and salts thereof. As for the kind of the polymer, descriptions are made on pages 1 to 4 in Kaitei Kobunshi Gousei no Kagaku (Revised Chemistry of Polymer Synthesis) (written by Takayuki OTSU and published by Kagaku-Dojin Publishing Company, Inc. (1968)). Examples thereof include polyolefins, polyesters, polyamides, polyimides, polyurethanes, polycarbonates, polysulfones, polycarbonates, polyethers, polyacetals, polyketones, polyphenylene oxides, polyphenylene sulfides, polyarylates, PTFEs, polyvinylidene fluorides, and cellulose derivatives. The fluorine based polymer is preferably a polyolefin.

The fluorine based polymer is a polymer having a fluoroaliphatic group in a side chain thereof. The fluoroaliphatic group has a carbon number of preferably from 1 to 12, and more preferably from 6 to 10. The aliphatic group may be of either a chain structure or a cyclic structure. In the case where the aliphatic group is of a chain structure, it may be either linear or branched. Above all, a linear fluoroaliphatic group having a carbon number of from 6 to 10 is preferable. Though a degree of substitution of the fluoroaliphatic group with a fluorine atom is not particularly limited, it is preferable that 50% or more of the hydrogen atoms in the aliphatic group are substituted with a fluorine atom, and it is more preferable that 60% or more of the hydrogen atoms in the aliphatic group are substituted with a fluorine atom. The fluoroaliphatic group is included in a side chain of the polymer connected to a main chain of the polymer via, for example, an ester bond, an amide bond, an imide bond, a urethane bond, a urea bond, an ether bond, a thioether bond, an aromatic ring, or the like.

Specific examples of the fluoroaliphatic group-containing copolymer which is preferably used in the invention as the fluorine based polymer include compounds described in paragraphs [0110] to [0114] of JP-A-2006-113500, but it should not be construed that the invention is limited to these specific examples.

A mass average molecular weight of the fluorine based polymer which is used in the invention is preferably 1,000,000 or less, more preferably 500,000 or less, and still more preferably from 100,000 or less and 10,000 or more. What the mass average molecular weight of the fluorine based polymer falls within the foregoing range is effective for controlling the alignment of the liquid crystalline compound while satisfying sufficient solubility. The mass average molecular weight can be measured as a value as reduced into polystyrene (PS) by means of gel permeation chromatography (GPC).

A preferred range of a content of the fluorine based polymer in the composition varies depending upon an application thereof. In the case of using the fluorine based polymer for forming the optically anisotropic layer, the content of the fluorine based polymer is preferably from 0.005 to 8% by mass, more preferably from 0.01 to 5% by mass, and still more preferably from 0.05 to 3% by mass in the composition (in the case of a coating solution, the composition exclusive of an solvent). When the addition amount of the fluorine based polymer is 0.005% by mass or more, the effects are sufficient, whereas when it is 8% by mass or less, drying of the coated film is sufficiently achieved, and excellent performances as the optical film (for example, uniformity of the retardation, etc.) are revealed.

The fluorine-containing compound represented by the following general formula (III) is described.)

(R⁰)ₘ-L⁰-(W)ₙ (III)

In the foregoing general formula (III), R⁰ represents an alkyl group, an alkyl group having a CF₃ group at a terminal thereof, or an alkyl group having a CF₂H group at a terminal thereof; and m represents an integer of 1 or more. When m is 2 or more, each R⁰ may be the same as or different from every other R⁰, provided that at least one R⁰ represents an alkyl group having a CF₃ group or a CF₂H group at a terminal thereof. L⁰ represents an (m+n) valent connecting group; W represents a carboxyl group (—COOH) or a salt thereof, a sulfo group (—SO₃H) or a salt thereof, or a phosphonoxy group {—OP(═O)(OH)₂} or a salt thereof; and n represents an integer of 1 or more.

Specific examples of the fluorine-containing compound represented by formula (III) which can be used in the invention include compounds described in paragraphs [0136] to [0140] of JP-A-2006-113500, but it should not be construed that the invention is limited to these specific examples.

A preferred range of a content of the fluorine-containing compound in the composition varies depending upon an application thereof. In the case of using the fluorine-containing compound for forming the optically anisotropic layer, the content of the fluorine-containing compound is preferably from 0.005 to 8% by mass, more preferably from 0.01 to 5% by mass, and still more preferably from 0.05 to 3% by mass in the composition (in the case of a coating solution, the composition exclusive of an solvent).

### [Polymerization Initiator]

The aligned (preferably vertically aligned) liquid crystalline compound is fixed while keeping its alignment state. Fixation is preferably conducted by a polymerization reaction of a polymerizable group having been introduced into the liquid crystalline compound. The polymerization reaction includes a thermal polymerization reaction using a thermal polymerization initiator and a photopolymerization reaction using a photopolymerization initiator, with a photopolymerization reaction being preferable. Examples of the photopolymerization initiator include an α-carbonyl compound (described in U.S. Pat. Nos. 2,367,661 and 2,367,670), an acyloin ether (described in U.S. Pat. No. 2,448,828), an α-hydrocarbon-substituted aromatic acyloin compound (described in U.S. Pat. No. 2,722,512), a polynuclear quinone compound (described in U.S. Pat. Nos. 3,046,127 and 2,951,758), a combination of a triarylimidazole dimer and p-aminophenyl ketone (described in U.S. Pat. No. 3,549,367), an acridine or phenazine compound (described in JP-A-60-105667 and U.S. Pat. No. 4,239,850), and an oxadiazole compound (described in U.S. Pat. No. 4,212,970).

In the invention, it is preferable to generate a radical within the optically anisotropic layer at the time of laminating the hard coat layer. For achieving this purpose, the optically anisotropic layer preferably contains a polymerization initiator whose photosensitive wavelength lies in a near ultraviolet region. In this way, adhesion between the hard coat layer and the optically anisotropic layer can be improved. In addition, in the case where the hard coat layer contains an ultraviolet ray absorber, effects of the initiator are remarkable.

The polymerization initiator whose photosensitive wavelength lies in a near ultraviolet region is preferably a compound having an absorption end at near 400 nm, for example, phosphine oxides such as 2,4,6-trimethylbenzoyl diphenyl phosphine oxide {“DAROCURTPO” (trade name); manufactured by Ciba Specialty Chemicals Inc.}, phenylenebis(2,4,6-trimethylbenzoyl)-phosphine oxide {“IRGACURE 819” (trade name); manufactured by Ciba Specialty Chemicals Inc.}, and bis(2,6-dimethoxybenzoyl)-2,4,4-trimethyl-pentylphosphine oxide; thioxanthones such as 2,4-diethylthioxanthone, 2-chlorothioxanthone, and 1-chloro-4-propoxythioxantone; ketones such as N-methyl acridone, bis(dimethylaminophenyl)ketone, and 2-benzyl-2-dimethylamino-1-(4-morpholinophenyl)-butane-1-one {“IRGACURE 369” (trade name); manufactured by Ciba Specialty Chemicals Inc.}; and oximes such as 1,2-octanedione-1-[4-(phenylthio)-2,2-(O-benzoyloxime). Of these, phosphine oxides are especially preferable because the fabricated optical film is less colored and large in decoloration after irradiation.

A use amount of the photopolymerization initiator is preferably from 0.01 to 20% by mass, and more preferably from 0.5 to 5% by mass, relative to a solid content of the coating solution. For light irradiation for the polymerization of liquid crystalline compound, it is preferable to use ultraviolet rays. An irradiation amount thereof is preferably from 10 mJ/cm² to 50 J/cm², more preferably from 20 to 400 mJ/cm², still more preferably from 30 to 300 mJ/cm², and especially preferably from 50 to 200 mJ/cm². In order to accelerate the photopolymerization reaction, the light irradiation may be conducted under a heating condition. An oxygen concentration at the time of irradiation with ultraviolet rays may be lowered to 0.1% or less; however, in order to leave the unsaturated double bond on the surface of the optically anisotropic layer after the irradiation with ultraviolet rays, it is preferable that the oxygen concentration is not lowered.

A thickness of the optically anisotropic layer is preferably from 0.1 to 10 μm, more preferably from 0.5 to 5 μm, and most preferably from 1 to 5 μm.

### [Non-Liquid Crystalline Compound Having an Unsaturated Double Bond]

It is preferable that a non-liquid crystalline compound having an unsaturated double bond is contained in the optically anisotropic layer forming composition according to the invention because a change of in-plane retardation after a light fastness test can be suppressed.

The compound having an unsaturated double bond is preferably a polyfunctional monomer having two or more polymerizable unsaturated groups, and more preferably a polyfunctional monomer having three or more polymerizable unsaturated groups.

Examples of the compound having an unsaturated double bond include compounds having a polymerizable functional group such as a (meth)acryloyl group, a vinyl group, a styryl group, and an allyl group. Above all, a (meth)acryloyl group and —C(O)OCH═CH₂ are preferable. Compounds containing 3 or more (meth)acryloyl groups in one molecule thereof as described below can be especially preferably used.

An addition amount of the foregoing non-liquid crystalline compound having an unsaturated double bond is preferably from 1 to 30% by mass, more preferably from 2 to 20% by mass, and especially preferably from 3 to 15% by mass, relative to the liquid crystalline compound. When the addition amount of the foregoing non-liquid crystalline compound having an unsaturated double bond is 30% by mass or less relative to the liquid crystalline compound, disorder of the alignment of the liquid crystal scarcely occurs, and light leakage is hardly caused. In consequence, by controlling the addition amount of the non-liquid crystalline compound having an unsaturated double bond within the foregoing range, the light fastness can be improved while suppressing the light leakage.

Specific examples of the compound having a polymerizable unsaturated group include (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy (meth)acrylates, urethane (meth)acrylates, and polyester (meth)acrylates.

Above all, esters between a polyhydric alcohol and (meth)acrylic acid are preferable. Examples thereof include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl)isocyanurate.

As the polyfunctional acrylate based compound having a (meth)acryloyl group, commercially available products can be used, and examples thereof include NK ESTER, manufactured by Shin-Nakamura Chemical Co., Ltd., KAYARAD, manufactured by Nippon Kayaku Co., Ltd., and BISCOAT, manufactured by Osaka Organic Chemical Industry Ltd.

### [Other Additives to Optically Anisotropic Layer]

A plasticizer or a surfactant can be used together with the foregoing liquid crystalline compound and the like to enhance uniformity of the coated film, strength of the film, alignment properties of the liquid crystalline compound, and the like. It is preferable that such a raw material has compatibility with the liquid crystalline compound and does not inhibit the alignment thereof.

As the surfactant, there are exemplified conventionally known compounds. Above all, fluorine based compounds are especially preferable. Specifically, examples thereof include compounds described in paragraphs [0028] to [0056] of JP-A-2001-330725 and compounds described in paragraphs [0069] to [0126] of JP-A-2005-62673.

It is preferable that the polymer which is used together with the liquid crystalline compound is able to thicken the coating solution. Examples of the polymer include cellulose esters. Preferred examples of the cellulose ester include those described in paragraph [0178] of JP-A-2000-155216. An addition amount of the foregoing polymer is preferably in the range of from 0.1 to 10% by mass, and more preferably in the range of from 0.1 to 8% by mass, relative to the liquid crystalline compound such that the alignment of the liquid crystalline compound is not inhibited.

A discotic nematic liquid crystal phase-solid phase transition temperature of the liquid crystalline compound is preferably from 70 to 300° C., and more preferably from 70 to 170° C.

In order that the liquid crystalline compound may be aligned without defects, the surface of the optically anisotropic layer containing a liquid crystalline compound according to the invention is preferably smooth. As for the smoothness of the layer, an arithmetic average roughness Ra in a roughness curve (JIS B0601:1998) is preferably in the range of from 0 to 0.05 μm, and more preferably in the range of from 0.01 to 0.04 μm. On such a smooth surface, the fluorine-containing compound for aligning the liquid crystalline compound tends to transfer upon contact with the surface on the opposing hard coat layer side in a roll state. However, according to the invention, this problem can be solved by controlling the shape of the surface on the opposing hard coat layer side or the surface free energy to a specified range.

### [Coating Solvent]

As a solvent which is used for the preparation of a coating solution, an organic solvent is preferably used. Examples of the organic solvent include amides (for example, N,N-dimethylformamide), sulfoxides (for example, dimethyl sulfoxide), heterocyclic compounds (for example, pyridine), hydrocarbons (for example, benzene and hexane), alkyl halides (for example, chloroform and dichloromethane), esters (for example, methyl acetate, ethyl acetate, and butyl acetate), ketones (for example, acetone and methyl ethyl ketone), and ethers (for example, tetrahydrofuran and 1,2-dimethoxyethane). Of these, alkyl halides and ketones are preferable. Two or more kinds of organic solvents may be used in combination.

### [Coating Method]

Coating of the coating solution can be conducted according to a known method (for example, a wire bar coating method, an extrusion coating method, a direct gravure coating method, a reverse gravure coating method, and a die coating method).

### [Alignment Film]

The optical film according to the invention preferably has an alignment film between the transparent support and the optically anisotropic layer. In the invention, it is preferable to coat the foregoing optically anisotropic layer forming composition on the surface of the alignment film, thereby aligning molecules of the liquid crystalline compound. Since the alignment film has a function to specify the alignment direction of the liquid crystalline compound, it is preferable to utilize the alignment film for the purpose of realizing a preferred embodiment of the invention.

The alignment film can be provided by means of, for example, a rubbing treatment of an organic compound (preferably a polymer), oblique vapor deposition of an inorganic compound, formation of a layer having microgrooves, or accumulation of an organic compound (for example, ω-tricosanic acid, dioctadecylmethylammonium chloride, and methyl stearate) by the Langmuir-Blodgett method (LB film). Furthermore, an alignment film which generates an alignment function upon application of an electric field, application of a magnetic field, or irradiation with light is also known.

The alignment film is preferably formed by a rubbing treatment of a polymer.

Examples of the polymer include a methacrylate based copolymer, a styrene based copolymer, a polyolefin, polyvinyl alcohol and a modified polyvinyl alcohol, poly(N-methylolacrylamide), a polyester, a polyimide, a vinyl acetate copolymer, carboxymethyl cellulose, and a polycarbonate described in paragraph [0022] of JP-A-8-338913. It is possible to use a silane coupling agent as the polymer. A water-soluble polymer (for example, poly(N-methylolacrylamide), carboxymethyl cellulose, gelatin, polyvinyl alcohol, and a modified polyvinyl alcohol) is preferable; gelatin, polyvinyl alcohol, and a modified polyvinyl alcohol are more preferable; and polyvinyl alcohol and a modified polyvinyl alcohol are the most preferable.

A degree of saponification of polyvinyl alcohol is preferably from 70 to 100%, and more preferably from 80 to 100%. A degree of polymerization of polyvinyl alcohol is preferably from 100 to 5,000.

In the alignment film, it is preferable to connect a side chain having a crosslinkable functional group (for example, a double bond) with a main chain thereof, or to introduce a crosslinkable functional group having a function to align the liquid crystalline compound into a side chain thereof. As the polymer which is used in the alignment film, any of a polymer which is crosslinkable itself or a polymer which is crosslinked with a crosslinking agent can be used, and a plurality of combinations thereof can be used.

By connecting a side chain having a crosslinkable functional group with a main chain of the alignment film polymer, or introducing a crosslinkable functional group into a side chain having a function to align the liquid crystalline compound, it is possible to copolymerize the polymer in the alignment film and the liquid crystalline compound contained in the optically anisotropic layer. As a result, not only between a polyfunctional monomer and a polyfunctional monomer but between an alignment film polymer and an alignment film polymer and also between a polyfunctional monomer and an alignment film polymer, a strong covalent bond is formed. In consequence, by introducing a crosslinkable functional group into the alignment film polymer, adhesion between the optically anisotropic layer and the alignment film can be remarkably improved.

Similar to the liquid crystalline compound to be contained in the optically anisotropic layer, the crosslinkable functional group of the alignment film polymer preferably has an unsaturated double bond group. Specifically, examples thereof include compounds having an unsaturated double bond group described in paragraphs [0080] to [0100] of JP-A-2000-155216.

In order to more increase the adhesion between the optically anisotropic layer and the alignment film, it is preferable to contain a photopolymerization initiator into the alignment film in addition to the introduction of an unsaturated double bond into the alignment film polymer. Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins.

In order to obtain the film hardness of the alignment film itself and the adhesion to the optically anisotropic layer, a content of the compound having an unsaturated double bond in the alignment film forming composition is preferably in the range of from 50 to 100% by mass, more preferably in the range of from 60 to 100% by mass, and still more preferably in the range of from 70 to 100% by mass, relative to all of the solids of the composition (in the case of a coating solution, the composition exclusive of an solvent).

A use amount of the photopolymerization initiator is preferably from 0.5 to 15% by mass, more preferably from 0.5 to 10% by mass, and especially preferably from 1 to 6% by mass, relative to the compound having an unsaturated double bond in the alignment film forming composition.

The alignment film polymer can also be crosslinked using a crosslinking agent apart from the foregoing crosslinkable functional group. Examples of the crosslinking agent include an aldehyde, an N-methylol compound, a dioxane derivative, a compound to act when its carboxyl group is activated, an active vinyl compound, an active halogen compound, an isoxazole, and a dialdehyde starch. Two or more kinds of crosslinking agents may be used in combination. Specifically, examples thereof include compounds described in paragraphs [0023] to [0024] of JP-A-2002-62426. An aldehyde with high reactivity, in particular, glutaraldehyde is preferable.

An addition amount of the crosslinking agent is preferably from 0.1 to 20% by mass, and more preferably from 0.5 to 15% by mass, relative to the polymer. An amount of the unreacted crosslinking agent remaining in the alignment film is preferably 1.0% by mass or less, and more preferably 0.5% by mass or less. By controlling the amount within the foregoing range, even when the alignment film is used in a liquid crystal display device for a long period of time or allowed to stand in a high temperature and high humidity atmosphere for a long period of time, sufficient durability without occurrence of reticulation is obtainable.

The alignment film can be fundamentally formed by coating a solution containing the polymer, the crosslinking agent, and the additives described above which are the materials for forming the alignment film on the transparent support, heat drying (to achieve crosslinking) and performing a rubbing treatment. As described above, the crosslinking reaction may be conducted at any time after coating the coating solution on the transparent support. In the case of using a water-soluble polymer such as polyvinyl alcohol as the alignment film forming material, the coating solution is preferably prepared by using a mixed solvent of an organic solvent having a defoaming action (for example, methanol) and water. A mass ratio of water/methanol is preferably from 0/100 to 99/1, and more preferably from 0/100 to 91/9. In this way, the generation of bubbles is suppressed, and defects on the layer surface of the alignment film and further the optically anisotropic layer can be remarkably reduced.

A coating method which is utilized at the time of formation of the alignment film is preferably a spin coating method, a dip coating method, a curtain coating method, an extrusion coating method, a rod coating method, or a roll coating method, with a rod coating method being especially preferable. In addition, a film thickness of the alignment film after drying is preferably from 0.1 to 10 μm, more preferably from 0.2 to 5 μm, still more preferably from 0.3 to 3.0 μm, and especially preferably from 0.4 to 2.0 μm. The heat drying can be conducted at from 20 to 110° C. In order to form sufficient crosslinking, the drying is conducted preferably at from 60 to 100° C., and especially preferably at from 80 to 100° C. Though the drying can be conducted for from 1 minute to 36 hours, the drying is preferably conducted for from 1 minute to 30 minutes. A pH is preferably set at a value which is optimum for the crosslinking agent to be used, and in the case of using glutaraldehyde, the pH is preferably from 4.5 to 5.5.

The alignment film is preferably provided on the transparent support. The alignment film can be obtained by crosslinking the polymer layer as described above and then subjecting a surface thereof to a rubbing treatment.

The rubbing treatment can be conducted according to a treatment method which is widely adopted as a liquid crystal alignment treatment step of LCD. That is, a method of attaining alignment by rubbing the surface of the alignment film with paper, gauze, felt, rubber, a nylon fiber, a polyester fiber, or the like in a definite direction can be adopted. In general, the rubbing treatment is conducted by rubbing several times with a fabric in which fibers having a uniform length and diameter are implanted averagely.

The foregoing composition is coated on the rubbing-treated surface of the alignment film, thereby aligning the molecules of the liquid crystalline compound. Thereafter, if desired, by allowing the alignment film polymer and the polyfunctional monomer contained in the optically anisotropic layer to react with each other, or crosslinking the alignment film polymer with a crosslinking agent, the optically anisotropic layer can be formed.

### [Hard Coat Layer]

The hard coat layer in the optical film according to the invention is hereunder described.

The “hard coat layer” as referred to in the invention means a layer in which when formed on the transparent support, a pencil hardness of the transparent support increases. Practically, the pencil hardness (JIS K5400) after laminating the hard coat layer is preferably H or more, more preferably 2H or more, and most preferably 3H or more.

A thickness of the hard coat layer is from 3 to 30 μm, preferably from 5 to 30 μm, and more preferably from 10 to 30 μm. When the thickness of the hard coat layer is less than 3 μm, because of poor blocking properties against oxygen, in the case where the resulting optical film is exposed to ultraviolet rays for a long period of time, deterioration of the optically anisotropic layer is advanced, and the retardation changes. In addition, when the thickness of the hard coat layer exceeds 30 μm, brittleness of the optical film is deteriorated.

In the invention, the hard coat layer may be either a single layer or plural layers. In the case where the hard coat layer is composed of plural layers, a total sum of the film thickness of all of the hard coat layers is preferably in the foregoing range.

The surface of the hard coat layer of the optical film according to the invention may be smooth, or may have concaves and convexes. In addition, if desired, for the purpose of imparting surface unevenness or internal scattering, a translucent particle can also be contained in the hard coat layer.

### [Material for Forming Hard Coat Layer]

In the invention, the hard coat layer can be formed by coating a composition containing a compound having an unsaturated double bond and a polymerization initiator and optionally, a translucent particle, a fluorine-containing compound or a silicone based compound, and a solvent on a support directly or via other layer, followed by drying and curing. The respective components are hereunder described.

### [Compound Having an Unsaturated Double Bond]

In order to form a covalent bond with the optically anisotropic layer, the composition for forming a hard coat layer according to the invention contains a compound having an unsaturated double bond. The compound having an unsaturated double bond can function as a binder, and it is preferably a polyfunctional monomer having two or more polymerizable unsaturated groups. The polyfunctional monomer having two or more polymerizable unsaturated groups can function as a curing agent and is able to enhance strength and scratch resistance of the coated film. The polyfunctional monomer more preferably has 3 or more polymerizable unsaturated groups. As the monomer, a monofunctional or bifunctional monomer and a trifunctional or higher-functional monomer may be used in combination.

Examples of the compound having an unsaturated double bond include compounds having a polymerizable functional group such as a (meth)acryloyl group, a vinyl group, a styryl group, and an allyl group. Above all, a (meth)acryloyl group and —C(O)OCH═CH₂ are preferable. Compounds having 3 or more (meth)acryloyl groups in one molecule thereof as described below can be especially preferably used.

Specific examples of the compound having a polymerizable unsaturated group include (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy (meth)acrylates, urethane (meth)acrylates, and polyester (meth)acrylates.

Above all, esters between a polyhydric alcohol and (meth)acrylic acid are preferable. Examples thereof include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolac tone-modified tris(acryloxyethyl)isocyanurate.

As the polyfunctional acrylate based compound having a (meth)acryloyl group, commercially available products can be used, and examples thereof include NK ESTER A-TMMT, manufactured by Shin-Nakamura Chemical Co., Ltd., KAYARAD DPHA, manufactured by Nippon Kayaku Co., Ltd., and BISCOAT, manufactured by Osaka Organic Chemical Industry Ltd. The polyfunctional monomer is described in paragraphs [0114] to [0122] of JP-A-2009-98658, and it may be similarly applied to the invention.

From the standpoints of adhesion to a support, low curling properties, and fixing properties of a fluorine-containing compound or a silicone based compound as described later, the compound having an unsaturated double bond is preferably a compound having a substituent with hydrogen bonding properties. The “substituent with hydrogen bonding properties” as referred to herein means a substituent wherein an atom with a large electronegativity, such as nitrogen, oxygen, sulfur, and a halogen, is connected with a hydrogen bond through a covalent bond. Specifically, examples thereof include OH—, SH—, —NH—, CHO—, and CHN—, and urethane (meth)acrylates and (meth)acrylates having a hydroxyl group are preferable. Commercially available polyfunctional acrylates having a (meth)acryloyl group can also be used, and examples thereof include NK OLIGO U4HA and NK ESTER A-TMM-3, both of which are manufactured by Shin-Nakamura Chemical Co., Ltd., and KAYARAD PET-30, manufactured by Nippon Kayaku Co., Ltd.

For the purpose of imparting a sufficient polymerization rate to provide sufficient hardness or the like, a content of the compound having an unsaturated double bond in the hard coat layer forming composition according to the invention is preferably 50% by mass or more, more preferably from 60 to 99% by mass, still more preferably from 70 to 99% by mass, and especially preferably from 80 to 99% by mass, relative to all of the solids in the hard coat layer forming composition.

### [Ultraviolet Ray Absorber]

To the hard coat layer, an ultraviolet ray absorber is preferably added. By adding an ultraviolet ray absorber to the hard coat layer, decomposition of the liquid crystalline compound of the optically anisotropic layer disposed inside (on the transparent support side) the hard coat layer to be caused due to ultraviolet rays can be suppressed, thereby preventing coloration to be caused due to the decomposition.

From the viewpoints of excellent absorbing ability of ultraviolet rays and favorable liquid crystal display properties, a transmittance of the hard coat layer after adding the ultraviolet ray absorber to the hard coat layer at a wavelength of 360 nm is from 0 to 50%, preferably from 0 to 30%, more preferably from 0 to 15%, and especially preferably from 0 to 10%. In addition, an ultraviolet ray absorber having a transmittance at a wavelength of 400 nm of from 80 to 100%, preferably from 85 to 100%, and more preferably from 90 to 100% is preferably used.

As the ultraviolet ray absorber, known ultraviolet ray absorbers can be used. Examples thereof include benzotriazole based, benzophenone based, salicylic acid phenyl ester based, and triazine based ultraviolet ray absorbers.

Examples of the benzotriazole based ultraviolet ray absorber include 2-(5-methyl-2-hydroxyphenyl)benzotriazole, 2-(2H-benzotriazol-2-yl)-p-cresol, 2-(2H-benzotriazol-2-yl)-4,6-di-tert-pentylphenol, and 2-(2′-hydroxy-5′-methacryloxyethylphenyl)-2H-benzotriazole.

Examples of the benzophenone based ultraviolet ray absorber include 2-hydroxy-4-octoxybenzophenone, 2,4-dihydroxybenzophenone, 2-hydroxy-4-methoxy-4′-chlorobenzophenone, 2,2-dihydroxy-4-methoxybenzophenone, and 2,2-dihydroxy-4,4′-dimethoxybenzophenone.

Examples of the salicylic acid phenyl ester based ultraviolet ray absorber include p-t-butylphenyl salicylate.

Examples of the triazine based ultraviolet ray absorber include 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-(2-hydroxy-4-propoxyphenyl)-1,3,5-triazine, 2,4-diphenyl-(2-hydroxy-4-butoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-tri azine, and 2,4-diphenyl-6-(2-hydroxy-4-butoxyethoxyphenyl)-1,3,5-triazine.

Of these ultraviolet ray absorbers, from the standpoints of an increase of the hardness of the hard coat layer, suppression of bleed out, and an enhancement of durability, compounds having a functional group (preferably an unsaturated double bond) which can be polymerized with the polymerizable monomer of the hard coat layer are preferably used.

Examples of such a compound having a polymerizable functional group include 2-hydroxybenzophenone derivatives and 2-hydroxyphenyl benzotriazole derivatives.

Specific examples of the 2-hydroxybenzophenone derivative include 2-hydroxy-4-acryloyloxybenzophenone, 2-hydroxy-4-methacryloyloxybenzophenone, 2-hydroxy-4-(2-acryloyloxy)ethoxybenzophenone, 2-hydroxy-4-(2-methacryloyloxy)ethoxybenzophenone, and 2-hydroxy-4-(2-methyl-2-acryloyloxy)ethoxybenzophenone.

Specific examples of the 2-hydroxyphenyl benzotriazole derivative include 2-[2′-hydroxy-5′-(methacryloyloxy)ethylphenyl]-2H-benzotriazole, 2-[2′-hydroxy-5′-(methacryloyloxy)phenyl]benzotriazole, 2-[2′-hydroxy-5′-(acryloyloxy)phenyl]benzotriazole, 2-[2′-hydroxy-3′-t-butyl-5′-(methacryloyloxy)phenyl]benzotriazole, 2-[2′-hydroxy-3′-methyl-5′-(acryloyloxy)phenyl]benzotriazole, 2-[2′-hydroxy-5′-(methacryloyloxypropyl)phenyl]-5-chlorobenzotriazole, 2-[2′-hydroxy-5′-(methacryloyloxyethyl)phenyl]benzotriazole, 2-[2′-hydroxy-5′-(acryloyloxyethyl)phenyl]benzotriazole, 2-[2′-hydroxy-3′-t-butyl-5′-(methacryloyloxyethyl)phenyl]benzotriazole, 2-[2′-hydroxy-3′-methyl-5′-(acryloyloxyethyl)phenyl]benzotriazole, 2-[2′-hydroxy-5′-(methacryloyloxypropyl)phenyl]-5-chlorobenzotriazole, 2-[2′-hydroxy-5′-(acryloyloxybutyl)phenyl]-5-methylbenzotriazole, and [2-hydroxy-3-t-butyl-5-(acryloyloxyethoxycarbonylethyl)phenyl]benzotriazole. Examples of commercially available products thereof include a trade name “RUVA-93” (2-[2′-hydroxy-5′-(methacryloyloxy)ethylphenyl]-2H-benzotriazole), manufactured by Otsuka Chemical Co., Ltd.

Two or more kinds of such ultraviolet ray absorbers having a polymerizable functional group can also be used. In addition, it is also possible to use the ultraviolet ray absorber having a polymerizable functional group in combination with an ultraviolet ray absorber not having a polymerizable functional group.

From the viewpoints of adhesion between the hard coat layer and the optically anisotropic layer, hardness of the hard coat layer, and suppression of coloration after a light fastness test, a content of the ultraviolet ray absorber is preferably from 1 to 5% by mass, more preferably from 1 to 4% by mass, and still more preferably from 1 to 3% by mass, relative to all of the solids of the hard coat layer forming composition.

Since a light transmittance in a wavelength region of from 200 to 340 nm follows the generally known Beer-Lambert law, the addition amount of the ultraviolet ray absorber and the thickness of the hard coat layer necessary for achieving a target for the foregoing light transmittance can be determined by means of calculation.

In the case where the hard coat layer is made of an ultraviolet ray-curable resin, for the purpose of improving the absorption of ultraviolet rays of an ultraviolet ray-sensitive radical polymerization initiator, it is preferable that a transmittance at a wavelength longer than 340 nm is high as far as possible. This purpose can be achieved by selecting an ultraviolet ray absorber whose absorption peak lies at a wavelength shorter than 340 nm. For example, in the benzotriazole based ultraviolet ray absorber, 2-(2′-hydroxy-5′-methacryloxyethylphenyl)-2H-benzotriazole and 2-(2H-benzotriazol-2-yl)-p-cresol are preferably used; and in the triazine based ultraviolet ray absorber, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-triazine, and 2,4-diphenyl-6-(2-hydroxy-4-butoxyethoxyphenyl)-1,3,5-triazine are preferably used.

### [Translucent Particle]

By containing a translucent particle in the hard coat layer according to the invention, it is also possible to impart a concavo-convex shape onto the surface of the hard coat layer or to impart an internal haze.

Examples of the translucent particle which can be used in the hard coat layer include a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60), a benzoguanamine-melamine-formaldehyde particle (refractive index: 1.68), a silica particle (refractive index: 1.46), an alumina particle (refractive index: 1.63), a zirconia particle, a titania particle, and a hollow particle or a particle having fine pores.

Of these, a crosslinked poly(meth)acrylate particle and a crosslinked poly(acryl-styrene) particle are preferably used, and by adjusting the refractive index of the binder in conformity with the refractive index of the every translucent particle selected from these particles, surface unevenness, surface haze, internal haze, and total haze suitable for the hard coat layer of the optical film according to the invention can be achieved.

The refractive index of the binder (translucent resin) is preferably from 1.45 to 1.70, and more preferably from 1.48 to 1.65.

In addition, a difference in the refractive index between the translucent particle and the binder for the hard coat layer {(refractive index of the translucent particle)−(refractive index of the hard coat layer excluding the translucent particle)} is preferably less than 0.05, more preferably from 0.001 to 0.030, and still more preferably from 0.001 to 0.020 in terms of an absolute value. What the difference in the refractive index between the translucent particle and the binder in the hard coat layer is less than 0.05 is preferable because an refraction angle of light by the translucent particle becomes smaller, the scattered light does not spread to a wide angle, and a deterioration action such as dissolution of polarization of the transmitted light of the optically anisotropic layer is not brought.

In order to realize the foregoing difference in the refractive index between the particle and the binder, the refractive index of the translucent particle may be adjusted, or the refractive index of the binder may be adjusted.

According to a first preferred embodiment, it is preferable to use a combination of a binder composed mainly of a trifunctional or higher-functional (meth)acrylate monomer (refractive index after curing: 1.50 to 1.53) and a translucent particle composed of a crosslinked poly(meth)acrylate/styrene polymer having an acryl content of from 50 to 100% by mass. It is easy to control the difference in the refractive index between the translucent particle and the binder to less than 0.05 by adjusting a composition ratio of the acrylic component having a low refractive index to the styrene component having a high refractive index. A ratio of the acrylic component to the styrene component is preferably from 50/50 to 100/0, more preferably from 60/40 to 100/0, and most preferably from 65/35 to 90/10 in terms of a mass ratio. A refractive index of the translucent particle composed of the crosslinked poly(meth)acrylate/styrene polymer is preferably from 1.49 to 1.55, more preferably from 1.50 to 1.54, and most preferably from 1.51 to 1.53.

According to a second preferred embodiment, an inorganic fine particle having an average particle size of from 1 to 100 nm is used in combination with a binder composed mainly of a trifunctional or higher-functional (meth)acrylate monomer to adjust a refractive index of the binder composed of the monomer and the inorganic fine particle, thereby adjusting a difference in the refractive index from the existing translucent particle. Examples of the inorganic particle include particles made of an oxide of at least one metal selected from silicon, zirconium, titanium, aluminum, indium, zinc, tin, and antimony. Specific examples thereof include SiO₂, ZrO₂, TiO₂, Al₂O₃, In₂O₃, ZnO, SnO₂, Sb₂O₃, and ITO. Of these, SiO₂, ZrO₂, and Al₂O₃ are preferable. The inorganic particle can be mixed in an amount in the range of from 1 to 90% by mass, and preferably from 5 to 65% by mass, relative to a total amount of the monomers and used.

Here, the refractive index of the hard coat layer excluding the translucent particle can be quantitatively evaluated by means of direct measurement by an Abbe refractometer or by measuring a spectral reflectance spectrum or spectral ellipsometry. The refractive index of the translucent particle is measured by a method wherein the translucent particle is dispersed in an equal amount in solvents prepared by changing a mixing ratio of two kinds of solvents having a different refractive index from each other to vary the refractive index, a turbidity is measured, and a refractive index of the solvent when the turbidity has become minimum is then measured by an Abbe refractometer.

An average particle diameter of the translucent particle is preferably from 1.0 to 12 μm, more preferably from 3.0 to 12 μm, still more preferably from 4.0 to 10.0 μm, and most preferably from 4.5 to 8 μm. By adjusting the difference in the refractive index and the particle size to the foregoing ranges, distribution of the scattering angle of light does not spread to a wide angle, and blurring of letters and reduction of contrast of a display hardly occur. The average particle diameter is preferably 12 μm or less from the standpoints that an increase in the thickness of the layer to which the translucent particle is added is not required; and that a problem such as curling and an increase in production costs is hardly caused. Furthermore, what the particle diameter is made to fall within the foregoing range is preferable from the standpoints that a coating amount at the time of coating can be reduced; that drying is rapidly achieved; and that defective surface properties such as drying unevenness are hardly generated.

As for a method for measuring the average particle diameter of the translucent particle, an arbitrary measuring method can be adopted so far as it is a method for measuring an average particle diameter of particle. Preferably, particles are observed by a transmission type electron microscope (magnification: 500,000 to 2,000,000 times), 100 particles are observed, and an average value thereof can be then taken as the average particle diameter.

A shape of the translucent particle is not particularly limited. However, in addition to a true spherical particle, a translucent particle having a different shape, for example, an irregularly shaped particle (for example, a non-true spherical particle) may also be used in combination. In particular, when non-true spherical particles are aligned so that a short axis thereof is uniformly directed in the normal line direction of the hard coat layer, a particle having a smaller particle diameter than that of a true spherical particle can be used.

The translucent particle is preferably blended such that it is contained in an amount of preferably from 0.1 to 40% by mass, more preferably from 1 to 30% by mass, and still more preferably from 1 to 20% by mass, relative to all of the solids of the hard coat layer. By allowing the blending ratio of the translucent particle to fall within the foregoing range, an internal haze can be controlled within a preferred range.

In addition, a coating amount of the translucent particle is preferably from 10 to 2,500 mg/m², more preferably from 30 to 2,000 mg/m², and still more preferably from 100 to 1,500 mg/m².

### <Preparation Method and Classification Method of Translucent Particle>

Examples of a method for manufacturing the translucent particle include a suspension polymerization method, an emulsion polymerization method, a soap-free emulsion polymerization method, a dispersion polymerization method, and a seed polymerization method, and the translucent particle may be manufactured by any of these methods. With respect to the manufacturing method, reference can be made, for example, to methods described in Kobunshi Gosei no Jikkenho (Experimental Method for Polymer Syntheses) (written by Takayuki OTSU and Masayoshi KINOSHITA and published by Kagaku-Dojin Publishing Company, Inc.), page 130 and pages 146 to 147, Gosei Kobunshi (Synthetic Polymer), Vol. 1, pages 246 to 290, and ibid., Vol. 3, pages 1 to 108; and methods described in Japanese Patents Nos. 2543503, 3508304, 2746275, 3521560 and 3580320, JP-A-10-1561, JP-A-7-2908, JP-A-5-297506, and JP-A-2002-145919.

As for the particle size distribution of the translucent particle, a monodisperse particle is preferable from the standpoints of control of haze value and diffusibility and homogeneity of coated surface properties. A CV value which expresses uniformity of the particle diameter is preferably 15% or less, more preferably 13% or less, and still more preferably 10% or less. Furthermore, in the case where a particle having a particle diameter larger than the average particle diameter by 20% or more is specified as a coarse particle, a proportion of this coarse particle is preferably 1% or less, more preferably 0.1% or less, and still more preferably 0.01% or less, relative to a total number of the particles. As a method for obtaining the particle having such particle size distribution, it is also effective to conduct classification after the preparation or synthesis reaction thereof, and a particle having desired distribution can be obtained by increasing a number of times of classification or intensifying a degree of classification.

For the classification, it is preferable to adopt a method such as an air classification method, a centrifugal classification method, a sedimentation classification method, a filtration classification method, and an electrostatic classification method.

### [Photopolymerization Initiator]

Next, a photopolymerization initiator which can be contained in the hard coat layer forming composition is described.

Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins. Specific examples, preferred embodiments, commercially available products, and the like of the photopolymerization initiator are described in paragraphs [0133] to [0151] of JP-A-2009-098658, and they can also be suitably adopted in the invention.

Various examples are also described in Saishin UV Koka Gijutsu (Latest UV Curing Technology), Technical Information Institute Co., Ltd., page 159 (1991), and Kiyomi KATO, Shigaisen Koka System (Ultraviolet Curing System), Sogo Gijutsu Center, pages 65 to 148 (1989), and these are useful in the invention.

As a commercially available photo cleavage type photo radical polymerization initiator, “IRGACURE 651”, “IRGACURE 184”, “IRGACURE 819”, “IRGACURE 907”, “IRGACURE 1870” (a mixed initiator of CGI-403 and Irg 184 (7/3)), “IRGACURE 500”, “IRGACURE 369”, “IRGACURE 1173”, “IRGACURE 2959”, “IRGACURE 4265”, “IRGACURE 4263”, “IRGACURE 127”, and “OXE 01”, all of which are manufactured by Ciba Specialty Chemicals Inc.; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC”, and “KAYACURE MCA”, all of which are manufactured by Nippon Kayaku Co., Ltd.; ESACURE Series, manufactured by Sartomer Company Inc. (for example, KIP100F, KB1, EB3, BP, X33, KT046, KT37, KIP150, and TZT); and combinations thereof are enumerated as preferred examples.

In the invention, in the case where an ultraviolet ray absorber is contained in the hard coat layer, the hard coat layer preferably contains a polymerization initiator whose photosensitive wavelength lies in a near ultraviolet region. By irradiation with ultraviolet rays at the time of lamination of the hard coat layer and curing, the ultraviolet rays in a near ultraviolet ray region reaches a lower layer of the hard coat layer without being absorbed by the ultraviolet ray absorber, thereby making it possible to increase a pencil hardness of the hard coat layer or to improve adhesion between the hard coat layer and the optically anisotropic layer.

The polymerization initiator whose photosensitive wavelength lies in a near ultraviolet region is preferably a compound having an absorption end at near 400 nm, for example, phosphine oxides such as 2,4,6-trimethylbenzoyl diphenyl phosphine oxide {“DAROCURTPO” (trade name); manufactured by Ciba Specialty Chemicals Inc.}, phenylenebis(2,4,6-trimethylbenzoyl)-phosphine oxide {“IRGACURE 819” (trade name); manufactured by Ciba Specialty Chemicals Inc.}, and bis(2,6-dimethoxybenzoyl)-2,4,4-trimethyl-pentylphosphine oxide; thioxanthones such as 2,4-diethylthioxanthone, 2-chlorothioxanthone, and 1-chloro-4-propoxythioxantone; ketones such as N-methyl acridone, bis(dimethylaminophenyl)ketone, and 2-benzyl-2-dimethylamino-1-(4-morpholinophenyl)-butane-1-one {“IRGACURE 369” (trade name); manufactured by Ciba Specialty Chemicals Inc.}; and oximes such as 1,2-octanedione-1-[4-(phenylthio)-2,2-(O-benzoyloxime). Of these, phosphine oxides are especially preferable because the fabricated optical film is less colored and large in decoloration after irradiation.

A content of the photopolymerization initiator in the hard coat layer forming composition according to the invention is preferably from 0.5 to 8% by mass, and more preferably from 1 to 5% by mass, relative all of the solids in the hard coat layer forming composition for the reason that the content is set to be sufficiently large for polymerizing a polymerizable compound which is contained in the hard coat layer forming composition and sufficiently small for preventing an excessive increase of initiation points.

### [Solvent]

The hard coat layer forming composition according to the invention may contain a solvent. As the solvent, various solvents can be used while taking into consideration solubility of the monomer, dispersibility of the translucent particle, drying properties at the time of coating, and the like. Examples of such an organic solvent include dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, and xylene. The solvents can be used solely or in combination of two or more kinds thereof.

The solvent is used in such an amount that a concentration of the solid content of the hard coat layer forming composition according to the invention falls within the range of preferably from 20 to 80% by mass, more preferably from 30 to 75% by mass, and still more preferably from 40 to 70% by mass.

The optical film according to the invention is preferably in a long roll form in which a slow axis of the in-plane retardation is present at from 5 to 85° in the clockwise or counterclockwise direction on the basis of the length direction.

### [Layer Configuration of Optical Film]

The optical film according to the invention has a hard coat layer on one side of a transparent support and an optically anisotropic layer on the other side of the transparent support and may further have a single layer or plural layers of necessary functional layers according to the need. For example, an antireflection layer (a layer having a controlled refractive index, such as a low refractive index layer, a medium refractive index layer, and a high refractive index layer), an antistatic layer, an ultraviolet ray absorbing layer, and the like can be provided. The hard coat layer may have antistatic properties or ultraviolet ray absorbing properties.

More specific examples of the layer configuration of the optical film according to the invention are shown below.

Transparent support/alignment film/optically anisotropic layer/hard coat layer

Transparent support/alignment film/optically anisotropic layer/hard coat layer/overcoat layer

Transparent support/alignment film/optically anisotropic layer/hard coat layer/low refractive index layer

Transparent support/alignment film/optically anisotropic layer/hard coat layer/high refractive index layer/low refractive index layer

Transparent support/alignment film/optically anisotropic layer/hard coat layer/medium refractive index layer/high refractive index layer/low refractive index layer

Transparent support/alignment film/optically anisotropic layer/hard coat layer/medium refractive index layer/high refractive index layer/low refractive index layer/antifouling layer

Of the foregoing configurations, it is preferable that a low refractive index layer is provided on an outermost surface layer on the hard coat layer side opposite to the transparent support.

### [Material of Low Refractive Index Layer]

Materials of the low refractive index layer are described below.

### [Inorganic Fine Particle]

From the viewpoints of reducing the refractive index and improving the scratch resistance, it is preferable to use an inorganic fine particle in the low refractive index layer. Though the inorganic fine particle is not particularly limited so far as it has an average particle size of from 5 to 120 nm, from the viewpoint of reducing the refractive index, an inorganic low refractive index particle is preferable.

Examples of the inorganic fine particle include a magnesium fluoride fine particle and a silica fine particle because of a low refractive index. In particular, from the standpoints of refractive index, dispersion stability, and costs, a silica fine particle is preferable. The size (primary particle diameter) of such an inorganic fine particle is preferably from 5 to 120 nm, more preferably from 10 to 100 nm, still more preferably from 20 to 100 nm, and most preferably from 30 to 90 nm.

When the particle diameter of the inorganic fine particle is too small, an effect for improving the scratch resistance decreases, whereas when it is too large, fine concaves and convexes are generated on the surface of the low refractive index layer, and an appearance, for example, denseness of black color, and an integrated reflectance are deteriorated. In addition, in the case of using a hollow silica fine particle as described later, when the particle diameter is too small, a proportion of the hollow portion is reduced, and a sufficient reduction of the refractive index cannot be expected. The inorganic fine particle may be either crystalline or amorphous, and it may be a monodisperse particle or may even be an aggregate particle so far as the prescribed particle diameter is satisfied. Though a shape of the inorganic fine particle is most preferably spherical, it may be amorphous.

A coating amount of the inorganic fine particle is preferably from 1 mg/m² to 100 mg/m², more preferably from 5 mg/m ² to 80 mg/m², and still more preferably from 10 mg/m² to 60 mg/m². When the coating amount is too small, a sufficient reduction of the refractive index cannot be expected, or an effect for improving the scratch resistance decreases, whereas when it is too large, fine concaves and convexes are generated on the surface of the low refractive index layer, and an appearance, for example, denseness of black color, and an integrated reflectance are deteriorated.

### (Porous or Hollow Fine Particle)

In order to contrive to reduce the refractive index, a fine particle having a porous or hollow structure is preferably used. In particular, a silica particle having a hollow structure is preferably used. A porosity of the particle is preferably from 10 to 80%, more preferably from 20 to 60%, and most preferably from 30 to 60%. What the porosity of the hollow fine particle is made to fall within the foregoing range is preferable from the viewpoints of reducing the refractive index and keeping durability of the particle.

In the case where the porous or hollow particle is made of silica, a refractive index of the fine particle is preferably from 1.10 to 1.40, more preferably from 1.15 to 1.35, and most preferably from 1.15 to 1.30. The refractive index as referred to herein means a refractive index of the particle as a whole and does not mean a refractive index of only silica in an outer shell forming the silica particle.

In addition, two or more kinds of the hollow silica having a different average particle size from each other can be used in combination. Here, the average particle diameter of the hollow silica can be determined from an electron microscopic photograph.

In the invention, a specific surface area of the hollow silica is preferably from 20 to 300 m²/g, more preferably from 30 to 120 m²/g, and most preferably from 40 to 90 m²/g. The surface area can be determined by the BET method using nitrogen.

In the invention, a void-free silica particle can be used in combination with the hollow silica. A particle size of the void-free silica is preferably 30 nm or more and 150 nm or less, more preferably 35 nm or more and 100 nm or less, and most preferably 40 nm or more and 80 nm or less.

### [Surface Treatment Method of Inorganic Fine Particle]

In addition, in the invention, the inorganic fine particle can be used upon being subjected to a surface treatment with a silane coupling agent or the like in the usual way.

In particular, in order to improve dispersibility into a binder for forming a low refractive index layer, it is preferable that the surface of the inorganic fine particle is treated with a hydrolyzate of an organosilane compound and/or a partial condensate thereof, and it is more preferable that either one or both of an acid catalyst and a metal chelate compound are used at the time of the treatment. The treatment method of the surface of the inorganic fine particle is described in paragraphs [0046] to [0076] of JP-A-2008-242314, and an organosilane compound, a siloxane compound, a solvent for the surface treatment, a catalyst for the surface treatment, a metal chelate compound, and the like described in the subject patent document can also be suitably used in the invention.

In the low refractive index layer, (b2) a fluorine-containing or non-fluorine-containing monomer having a polymerizable unsaturated group can be used. As for the non-fluorine-containing monomer, the compounds having an unsaturated double bond described previously as the compounds which can be used in the hard coat layer are also preferably used. As the fluorine-containing monomer, (d) a fluorine-containing polyfunctional monomer represented by the following general formula (1), which contains fluorine in an amount of 35% by mass or more and in which a calculated value of all inter-crosslinking molecular weights is less than 500, is preferably used.

Rf2{-(L)ₘ-Y}ₙ General Formula (1)

In the foregoing general formula (1), Rf2 represents an n-valent group containing at least a carbon atom and a fluorine atom; n represents an integer of 3 or more; L represents a single bond or a divalent connecting group; m represents 0 or 1; and Y represents a polymerizable unsaturated group.

Rf2 may contain at least either an oxygen atom or a hydrogen atom. In addition, Rf2 is a chain structure (linear or branched structure) or a cyclic structure.

Y is preferably a group containing two carbon atoms forming an unsaturated bond, more preferably a radical polymerizable group, and especially preferably a group selected from a (meth)acryloyl group, an allyl group, an α-fluoroacryloyl group, and —C(O)OCH═CH₂. Of these groups, from the viewpoint of polymerizability, a (meth)acryloyl group, an allyl group, an α-fluoroacryloyl group, and —C(O)OCH═CH₂, all of which have radical polymerizability, are more preferable.

L represents a divalent connecting group, and in detail, it represents an alkylene group having a carbon number of from 1 to 10, an arylene group having a carbon number of from 6 to 10, —O—, —S—, —N(R)—, a group obtained by combining an alkylene group having a carbon number of from 1 to 10 with —O—, —S—, or —N(R)—, or a group obtained by combining an arylene group having a carbon number of from 6 to 10 with —O—, —S—, or —N(R)—. R represents a hydrogen atom or an alkyl group having a carbon number of from 1 to 5. In the case where L represents an alkylene group or an arylene group, the alkylene group or arylene group represented by L is preferably substituted with a halogen atom, and more preferably substituted with a fluorine atom.

Specific examples of the compound represented by the general formula (1) are described in paragraphs [0121] to [0163] of JP-A-2010-152311.

### [Method for Manufacturing Optical Film]

A method for manufacturing the optical film according to the invention includes a step of coating an optically anisotropic layer forming composition containing a liquid crystalline compound having an unsaturated double bond on a transparent support and irradiating the coated optically anisotropic layer forming composition with ionizing radiations, thereby forming an optically anisotropic layer in a semi-cured state; and a step of coating a hard coat layer forming composition directly on the optically anisotropic layer in a semi-cured state and irradiating the coated hard coat layer forming composition and the optically anisotropic layer in a semi-cured state with ionizing radiations, thereby not only forming a hard coat layer but further curing the optically anisotropic layer in a semi-cured state. Preferably, the method includes a step of forming an alignment film on the transparent support prior to coating an optically anisotropic layer forming composition; and a step of coating an optically anisotropic layer forming composition directly on the alignment film.

The optically anisotropic layer in a semi-cured state as referred to herein means that a retention ratio of a double bond in the liquid crystalline compound having an unsaturated double bond, which is contained in the optically anisotropic layer, is 30% or more of the amount of the unsaturated double bond before the irradiation with ionizing radiations. The retention ratio is preferably from 30 to 80%, more preferably from 40 to 70%, and still more preferably from 45 to 65%.

In order to form the optically anisotropic layer in a semi-cured state, an irradiation amount of ionizing radiations is preferably from 10 mJ/cm² to 50 J/cm², more preferably from 20 to 400 mJ/cm², still more preferably from 30 to 300 mJ/cm², and especially preferably from 50 to 200 mJ/cm².

As described above, by coating a hard coat layer forming composition directly on the optically anisotropic layer in a semi-cured state while leaving the unsaturated double bond of the optically anisotropic layer, and irradiating the hard coat layer forming composition and the optically anisotropic layer in a semi-cured state with ionizing radiations, thereby not only forming a hard coat layer but further curing the optically anisotropic layer in a semi-cured state, a covalent bond is formed at an interface between the optically anisotropic layer and the hard coat layer due to polymerization of the unsaturated double bond (the unsaturated double bond of the liquid crystalline compound constituting the optically anisotropic layer and the unsaturated double bond of the compound constituting the hard coat layer are polymerized with each other to form a covalent bond), so that the adhesion can be enhanced.

### (Method for Coating Hard Coat Layer)

The hard coat layer for the optical film according to the invention can be formed according to the following method.

First of all, a hard coat layer forming composition is prepared. Subsequently, the composition is coated on a transparent support by a dip coating method, an air knife coating method, a curtain coating method, a roller coating method, a wire bar coating method, a gravure coating method, a die coating method, or the like, followed by heating and drying. A micro gravure coating method, a wire bar coating method, and a die coating method (see U.S. Pat. No. 2,681,294 and JP-A-2006-122889) are more preferable, with a die coating method being especially preferable.

After being coated on the transparent support, the hard coat layer is conveyed as a web into a heated zone for drying a solvent. On that occasion, a temperature in the drying zone is preferably from 25° C. to 140° C. It is preferable that the temperature in the first half of the drying zone is a comparatively low temperature; and that the temperature in the second half of the drying zone is a comparatively high temperature. However, the temperature is preferably not higher than a temperature at which the components other than the solvent contained in the coating composition for each layer start to volatilize. For example, some of commercially available photo radical generators which are used in combination with an ultraviolet ray-curable resin volatilize in an amount of about several 10% thereof within several minutes in hot air at 120° C., and some of monofunctional or bifunctional acrylate monomers or the like undergo the progress of volatilization in hot air at 100° C. In such cases, as described above, the temperature is preferably not higher than a temperature at which the components other than the solvent contained in the coating composition for hard coat layer start to volatilize.

In addition, in order to prevent the occurrence of drying unevenness, as for the drying air applied after coating the coating composition for hard coat layer on a base material film, an air velocity thereof on the coated film surface is preferably in the range of from 0.1 to 2 m/sec during a period wherein a solid content concentration in the coating composition is from 1 to 50%.

In addition, after coating the coating composition for hard coat layer on the base film, what a difference in temperature between a conveying roll coming into contact with the side of the base material film opposite to the coated surface and the base material film within a drying zone is controlled within the range of from 0° C. to 20° C. is preferable because the occurrence of drying unevenness due to uneven heat transmission on the conveying roll can be prevented.

After the drying zone for drying the solvent, the film is allowed to pass as a web through a zone where the hard coat layer is cured upon irradiation with ionizing radiations to cure the coated film. For example, in the case where the coated film is curable with ultraviolet rays, it is preferable to cure the coated film upon irradiation with ultraviolet rays in an irradiation amount from 10 mJ/cm² to 1,000 mJ/cm² using an ultraviolet ray lamp. On that occasion, the irradiation amount distribution in the width direction of the web including both edge portions is preferably from 50 to 100%, and more preferably from 80 to 100%, relative to a maximum irradiation amount at the center. Furthermore, for the purpose of accelerating surface curing, in the case where it is necessary to reduce an oxygen concentration by purging with a nitrogen gas or the like, the oxygen concentration is preferably from 0.01 to 5%, and its distribution in the width direction is preferably 2% or less. In the case of irradiation with ultraviolet rays, ultraviolet rays emitted from beams of light, for example, a super high pressure mercury vapor lamp, a high pressure mercury vapor lamp, a low pressure mercury vapor lamp, a carbon arc lamp, a xenon arc, or a metal halide lamp, or the like can be utilized. In addition, for the purpose of accelerating the curing reaction, it is possible to increase the temperature at the time of curing. In that case, the temperature is preferably from 25 to 100° C., more preferably from 30 to 80° C., and most preferably from 40 to 70° C.

The hard coat layer according to the invention can be coated, dried, and cured in this way. In addition, other functional layers can be provided, if desired. In the case of laminating other functional layers in addition to the hard coat layer, plural layers may be coated simultaneously or successively. A method for manufacturing such other functional layers can be conducted in conformity with the method for manufacturing the hard coat layer.

### [Polarizing Plate]

The polarizing plate according to the invention is preferably a polarizing plate comprising a polarizing film and two protective films for protecting both surfaces of the polarizing film, wherein at least one of the protective films is the optical film according to the invention.

The polarizing plate according to the invention is more preferably a polarizing plate comprising at least one protective film and a polarizing film, wherein the at least one protective film is the optical film according to the invention, and the transparent support side of the optical film and the polarizing film are stuck to each other. Here, the transparent support and the polarizing film are preferably stuck to each other directly or via an adhesive layer or a pressure-sensitive adhesive layer.

Examples of the polarizing film include an iodine based polarizing film, a dye based polarizing film using a dichromatic dye, and a polyene based polarizing film. The iodine based polarizing film and the dye based polarizing film can be in general manufactured by using a polyvinyl alcohol based film.

A configuration of the polarizing plate wherein the transparent support side of the optical film is adhered to one side of the polarizing film via an adhesive or other base material, and a protective film is provided on the other side of the polarizing film is preferable. A configuration of the polarizing plate wherein the transparent support of the optical film is adhered directly to the polarizing film via an adhesive is more preferable. In order to improve adhesiveness between the transparent support and the polarizing film, the surface of the transparent support is preferably subjected to a surface treatment (for example, a glow discharge treatment, a corona discharge treatment, a plasma treatment, an ultraviolet ray (UV) treatment, a flame treatment, a saponification treatment, and solvent washing). In addition, an adhesive layer (undercoat layer) may be provided on the transparent support.

In addition, a pressure-sensitive adhesive layer may be provided on the side of the other protective film constituting the polarizing plate opposite to the polarizing film.

By using the optical film according to the invention as a protective film for polarizing plate, it is possible to fabricate a polarizing plate having excellent physical strength, antifouling properties and durability in addition to optical performances expected for a λ/4 film or the like. The optical film according to the invention is suitably used as a surface film for liquid crystal display device.

In addition, the polarizing plate according to the invention can also have an optically compensatory function. In that case, it is preferable to use the optical film according to the invention as a protective film on one side of the polarizing film and an optically compensatory film as a protective film on the other surface of the polarizing film.

### [Image Display Device]

The optical film and the polarizing plate according to the invention are suitably used in an image display device such as a liquid crystal display device (LCD), a plasma display panel (PDP), an electroluminescence display (ELD), and a cathode ray tube display device (CRT). In particular, the optical film and the polarizing plate according to the invention are preferably used in the liquid crystal display device and are suitable for a stereoscopic image display device (3D display device). Above all, it is especially preferable to use the optical film and the polarizing plate according to the invention in a transmission type liquid crystal display device of field-sequential two eyes stereoscopic vision.

In general, the liquid crystal display device has a liquid crystal cell and two polarizing plates disposed on the both sides of the liquid crystal cell, and the liquid crystal cell bears a liquid crystal between two electrode substrates.

A preferred embodiment of the liquid crystal display device according to the invention is a liquid crystal display device comprising the optical film according to the invention, a polarizing film, and a liquid crystal cell in this order from the viewing side, wherein the optical film is disposed in such a manner that the hard coat layer is located on the viewing side, whereas the transparent support is located on the polarizing film side.

The liquid crystal cell is preferably of a TN mode, a VA mode, an OCB mode, an IPS mode, or an ECB mode.

### EXAMPLES

The characteristic features of the invention are hereunder more specifically described with reference to the following Examples and Comparative Examples. The materials, use amounts, proportions, contents of treatments, treating procedures, and the like as shown in the following Examples and Comparative Examples can be properly altered so far as the gist of the invention is not deviated. In consequence, it should not be construed that the scope of the invention is limited to the specific examples described below. Incidentally, all parts and percentages are on a mass basis, unless otherwise indicated specifically.

### Example 1

### <Fabrication of Transparent Support (Cellulose Acetate Film T1)>

The following composition was charged in a mixing tank and stirred with heating to solve the respective components, thereby preparing a cellulose acetate solution (dope A) having a solid content concentration of 22% by mass.

### [Composition of Cellulose Acetate Solution (Dope A)]

| | |
|---|---|
| Cellulose acetate having a degree of acetyl | 100 parts by mass |
| substitution of 2.86: | |
| Triphenyl phosphate (plasticizer): | 7.8 parts by mass |
| Biphenyl diphenyl phosphate (plasticizer): | 3.9 parts by mass |
| Ultraviolet ray absorber (TINUVIN 328, | 0.9 parts by mass |
| manufactured by Ciba Specialty Chemicals Inc.): | |
| Ultraviolet ray absorber (TINUVIN 326, | 0.2 parts by mass |
| manufactured by Ciba Specialty Chemicals Inc.): | |
| Methylene chloride (first solvent): | 336 parts by mass |
| Methanol (second solvent): | 29 parts by mass |
| 1-Butanol (third solvent): | 11 parts by mass |

To the foregoing dope A, a silica particle having an average particle diameter of 16 nm (AEROSIL R972, manufactured by Nippon Aerosil Co., Ltd.) was added in an amount of 0.02 pats by mass based on 100 parts by mass of cellulose acetate, thereby preparing a matting agent-incorporated dope B. The dope B was adjusted so as to have a solid content concentration of 19% by mass using the same solvent composition as that in the dope A.

Casting was conducted using a band stretching machine such that the dope A formed the main stream, whereas the matting agent-incorporated dope B formed both a lowermost layer and an uppermost layer. After a surface temperature of the film on the band reached 40° C., the film was dried for 1 minute with hot air at 70° C. and removed from the band. The film was then dried for 10 minutes with drying air at 140° C. to fabricate a cellulose acetate film T1 having a residual solvent amount of 0.3% by mass. A flow rate was adjusted in such a manner that a thickness of each of the lowermost layer and the uppermost layer, both of which were incorporated with the matting agent, became 3 μm, whereas a thickness of the main stream became 74 μm.

The thus obtained long cellulose acetate film T1 had a width of 2,300 mm and a thickness of 80 μm. In addition, the obtained cellulose acetate film T1 had an in-plane retardation (Re) of 3 nm and a retardation in the thickness direction (Rth) of 45 nm at a wavelength of 550 nm. In addition, the obtained cellulose acetate film T1 had a transmittance of 3.8% at 380 nm and an average transmittance of 92% at from 450 to 650 nm.

The measurement of the retardation was conducted according to the method described in this specification.

The transmittance was measured by a spectrophotometer.

### <Fabrication of Optical Base Material F1>

### <<Formation of Optically Anisotropic Layer Containing Liquid Crystalline Compound>>

(Saponification Treatment with Alkali)

The cellulose acetate film T1 was allowed to pass through induction heating rolls having a temperature of 60° C. to raise a surface temperature of the film to 40° C., and an alkali solution having a composition shown below was then coated on the band surface of the film in a coating amount of 14 ml/m² using a bar coater. The film was then conveyed for 10 seconds under a steam type far-infrared ray heater, manufactured by Noritake Co., Limited, heated at 110° C. Subsequently, pure water was similarly coated in an amount of 3 mL/m² using a bar coater. Subsequently, the procedures of washing with water by a fountain coater and water removal by an air knife were repeated three times, and the film was then conveyed into a drying zone at 70° C. for 10 seconds to achieve drying, thereby fabricating a cellulose acetate film which had been subjected to a saponification treatment with an alkali.

### [Composition of Alkali Solution]

| | |
|---|---|
| Potassium hydroxide: | 4.7 parts by mass |
| Water: | 15.8 parts by mass |
| Isopropanol: | 63.7 parts by mass |
| Surfactant SF-1: | 1.0 part by mass |
| C₁₄H₂₉O(CH₂CH₂O)₂₀H: | |
| Propylene glycol: | 14.8 parts by mass |

### (Formation of Alignment Film)

A coating solution for alignment film having the following composition was continuously coated on the foregoing long cellulose acetate film having been subjected to a saponification treatment using a wire bar. The coated film was dried for 60 seconds with hot air at 60° C. and further dried for 120 seconds with hot air at 100° C. The alignment film had a thickness of 0.7 μm.

### [Composition of Coating Solution for Alignment Film]

| | |
|---|---|
| Modified polyvinyl alcohol described below: | 100 parts by mass |
| Water: | 3,710 parts by mass |
| Methanol: | 1,190 parts by mass |
| Glutaraldehyde: | 5 parts by mass |
| Photopolymerization initiator (IRGACURE 2959, | 3 parts by mass |
| manufactured by Ciba Specialty Chemicals Inc.): | |

Modified polyvinyl alcohol

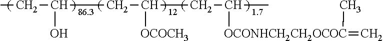

### (Formation of Optically Anisotropic Layer Containing Discotic Liquid Crystalline Compound)

The above-fabricated alignment film was continuously subjected to a rubbing treatment. At that time, the longitudinal direction of the long film and the conveying direction were parallel to each other, and a rotation axis of the rubbing roller was in the direction of 45° counterclockwise with respect to the longitudinal direction of the film.

A coating solution (A) containing a discotic crystalline compound having the following composition was continuously coated on the above-fabricated alignment film using a wire bar of #3.6. A conveying velocity (V) of the film was adjusted to 36 m/min. The film was heated for 90 seconds with hot air at 120° C. for drying the solvent of the coating solution and alignment and ripening of the discotic liquid crystalline compound. Subsequently, the film was irradiated at 80° C. with ultraviolet rays at an illuminance of 400 mW/cm² and an irradiation amount of 100 mJ/cm² using an air-cooled metal halide lamp of 160 W/cm (manufactured by Eye Graphics Co., Ltd.) to fix alignment of the liquid crystalline compound and form an optically anisotropic layer having a thickness of 1.6 μm, followed by winding up. There was thus obtained an optical base material F1.

The fabricated optical base material F1 had an Re of 125 nm at 550 nm. A slow axis thereof was in the direction of 45° clockwise with respect to the length direction of the film. An average tilt angle of the disc plane of the discotic crystalline compound was 90° with respect to the film plane, and it was confirmed that the discotic liquid crystal was vertically aligned with respect to the film plane. An arithmetic average roughness Ra (JIS B0601:1998) of the surface on the side of the optically anisotropic layer was in the range from 0.01 to 0.04 μm, and thus, the surface had high smoothness.

### [Composition of Coating Solution (A) for Optically Anisotropic Layer]

| | | |
|---|---|---|
| Discotic liquid crystalline compound DLC-A described below: | 100 | parts by mass |
| Acrylate monomer (1) described below: | 5 | parts by mass |
| Photopolymerization initiator (IRGACURE 907, manufactured by Ciba Specialty Chemicals Inc.): | 3 | parts by mass |
| Sensitizer (KAYACURE DETX, manufactured by Nippon Kayaku Co., Ltd.): | 1 | part by mass |
| Pyridinium salt (1) described below: | 0.5 | parts by mass |
| Fluorine based polymer (FP1) described below: | 0.2 | parts by mass |
| Fluorine based polymer (FP3) described below: | 0.1 | parts by mass |
| Methyl ethyl ketone: | 189 | parts by mass |

Discotic liquid crystalline compound DLC-A 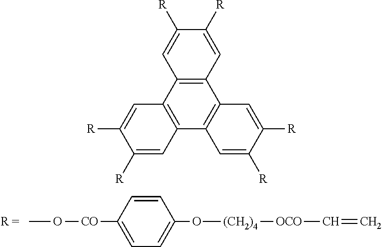
Acrylate monomer (1)
Ethylene oxide-modified trimethylolpropane triacrylate (V#360, manufactured by Osaka Organic Chemical Industry Ltd.)
Pyridinium salt (1) 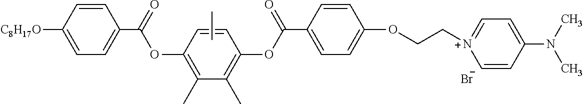
Fluorine based polymer (FP1) 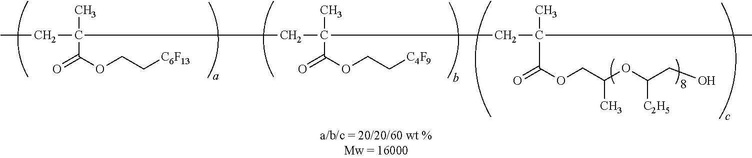
Fluorine based polymer (FP3)

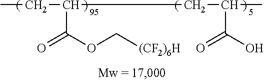

### <Fabrication of Optical Base Materials F2 to F9>

Optical base materials F2 to F9 were fabricated in the same manner as that in the fabrication method of the optical base material F1, except for changing the thickness of the optically anisotropic layer such that the Re value of the optically anisotropic layer was a value shown in Table 1. All of arithmetic average roughnesses Ra (JIS B0601:1998) of the surface on the side of the optically anisotropic layer were in the range from 0.01 to 0.04 μm, and thus, the surface had high smoothness.

### <Fabrication of Optical Base Material F10>

The alignment film of the base material (having the alignment film formed) before the formation of the optically anisotropic layer used in the fabrication of the optical base material F1 was continuously subjected to a rubbing treatment. At that time, the longitudinal direction of the long film and the conveying direction were parallel to each other, and a rotation axis of the rubbing roller was in the direction of 45° counterclockwise with respect to the longitudinal direction of the film.

By using a coating solution (containing a rod-shaped liquid crystalline compound RLC described below) for first optically anisotropic layer described in paragraph [0117] of JP-A-2004-272202, the coating solution was coated on the alignment film while controlling the coating amount so as to have an Re of 125 nm at 550 nm and irradiated with ultraviolet rays at an illuminance of 400 mW/cm² and an irradiation amount of 100 mJ/cm² to fix alignment of the liquid crystalline compound and form an optically anisotropic layer, followed by winding up. There was thus obtained an optical base material F10.

### Rod-Shaped Liquid Crystalline Compound RLC

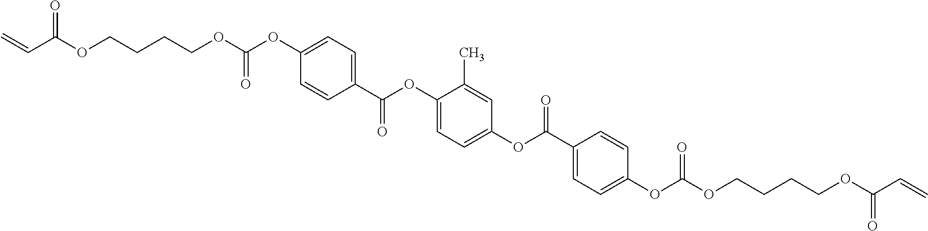 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

The fabricated optical base material F10 had an Re of 125 nm at 550 nm. A slow axis thereof was in the direction of 45° clockwise with respect to the longitudinal direction of the film. An average tilt angle of the rod-shaped crystalline compound was 0° with respect to the film plane, and it was confirmed that the rod-shaped liquid crystalline compound was horizontally aligned with respect to the film plane. An arithmetic average roughness Ra (JIS B0601:1998) of the surface on the side of the optically anisotropic layer was in the range from 0.01 to 0.04 μm, and thus, the surface had high smoothness.

### [Lamination of Hard Coat Layer]

A coating solution for forming each layer shown below was prepared.

### (Preparation of Coating Solution HC-1 for Hard Coat Layer)

| | |
|---|---|
| PET-30 (100%): | 60.0 g |
| BISCOAT 360 (100%): | 35.5 g |
| IRGACURE 127 (100%): | 3.0 g |
| CAB polymer (20% solution): | 7.0 g |
| SP-13 (5% solution): | 2.3 g |
| MIBK: | 60.0 g |
| MEK: | 26.0 g |

The foregoing coating solution for hard coat layer was filtered through a polypropylene-made filter having a pore size of 30 μm to prepare a coating solution. As for the foregoing coating solution, a refractive index of the matrix after curing was 1.525.

The materials used are shown below.
PET-30: Mixture of pentaerythritol triacrylate and pentaerythritol tetraacrylate [manufactured by Nippon Kayaku Co., Ltd.]
BISCOAT 360: Ethylene oxide-modified trimethylolpropane triacrylate [manufactured by Osaka Organic Chemical Industry Ltd.]
CAB polymer: Cellulose acetate butyrate (20% solution) [MIBK solution of CAB-531-1, manufactured by Eastman Chemical Company]
IRGACURE 127: Polymerization initiator [manufactured by Ciba Specialty Chemicals Inc.]
MEK: Methyl ethyl ketone
MIBK: Methyl isobutyl ketone
Leveling agent
(SP-13): 5% MEK solution of fluorine polymer described below

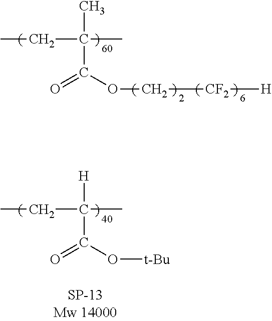

### (Preparation of Coating Solution Ln-1 for Low Refractive Index Layer)

Respective components shown below were mixed and dissolved in an MEK/MMPG-Ac mixture (90/10 in a mass ratio) to prepare a coating solution for low refractive index layer having a solid content of 5% by mass.

### (Composition of Ln-1)

| | |
|---|---|
| Perfluoroolefin copolymer (P-1) | 15 parts by mass |
| described below: | |
| DPHA: | 7 parts by mass |
| RMS-033: | 5 parts by mass |
| Fluorine-containing monomer (M-1) | 20 parts by mass |
| described below: | |
| Hollow silica particle (as a solid content): | 50 parts by mass |
| IRGACURE 127: | 3 parts by mass |

The compounds used are shown below.

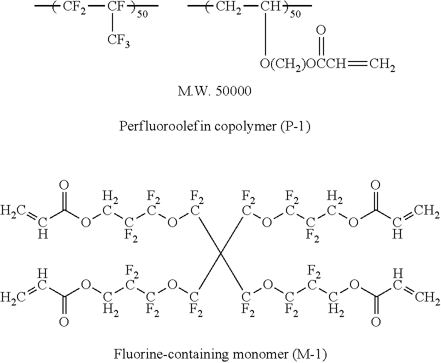

DPHA: Mixture of dipentaerythritol pentaacrylate and dipentaerythritol hexaacrylate, manufactured by Nippon Kayaku Co., Ltd.
RMS-033: Silicone based polyfunctional acrylate (manufactured by Gelest, Mwt=28,000)
IRGACURE 127: Photopolymerization initiator, manufactured by Ciba Specialty Chemicals Inc.
Hollow silica: Hollow silica particle dispersion liquid (average particle size: 45 nm, refractive index: 1.25; the surface thereof having been subjected to a surface treatment with a silane coupling agent having an acryloyl group; MEK dispersion liquid concentration: 20%)
MEK: Methyl ethyl ketone
MMPG-Ac: Propylene glycol monomethyl ether acetate

The foregoing coating solution for low refractive index layer was filtered through a polypropylene-made filter having a pore size of 1 μm to prepare a coating solution. The refractive index after curing of the low refractive index layer obtained by coating and curing the foregoing coating solution Ln-1 for low refractive index layer was 1.36.

### [Fabrication of Optical Film Sample]

### (Fabrication of Optical Film Sample 101)

The above-fabricated optical base material F1 was unwound from the roll form, and the coating solution HC-1 for hard coat layer was coated on the surface of the optically anisotropic layer according to a die coating method using a slot die described in Example 1 of JP-A-2006-122889 under a condition at a conveying velocity of 30 m/min. After drying at 60° C. for 150 seconds, the coated layer was further cured by irradiating with ultraviolet rays at an illuminance of 400 mW/cm² and an irradiation amount of 100 mJ/cm² using an air-cooled metal halide lamp of 160 W/cm (manufactured by Eye Graphics Co., Ltd.) under a condition of an oxygen concentration of about 0.1% while purging with nitrogen, followed by winding up the film. The coating amount was adjusted so as to have a film thickness of the hard coat layer of 3 μm.

Furthermore, the above-fabricated hard coat film was unwound from the roll form, and the coating solution Ln-1 for low refractive index layer was coated on the side on which the hard coat layer was coated, to fabricate an optical film sample 101. A drying condition of the low refractive index layer was controlled at 60° C. for 60 seconds. A curing condition with ultraviolet rays was controlled at an illuminance of 600 mW/cm² and an irradiation amount of 300 mJ/cm² using an air-cooled metal halide lamp of 240 W/cm (manufactured by Eye Graphics Co., Ltd.) in an atmosphere of an oxygen concentration of 0.1% by volume or less while purging with nitrogen. A refractive index of the low refractive index layer was 1.36, and a film thickness thereof was 95 nm.

### (Fabrication of Optical Film Samples 102 to 107)

Optical film samples 102 to 107 were fabricated in the same manner as that in the fabrication of the optical film sample 101, except that with respect to the above-fabricated optical film sample 101, the film thickness of the hard coat layer was changed as shown in Table 1.

### (Fabrication of Optical Film Sample 108)

An optical film sample 108 was fabricated in the same manner as that in the fabrication of the optical film sample 105, except that with respect to the above-fabricated optical film sample 105, the irradiation amount after coating the coating solution HC-1 for hard coat layer was changed from 100 mJ/cm² to 300 mJ/cm² and that the low refractive index layer was not laminated.

### (Fabrication of Optical Film Sample 109)

A sample in which with respect to the above-fabricated optical film sample 105, neither the hard coat layer nor the low refractive index layer was laminated, namely, the optical base material F1, was designated as an optical film sample 109.

### (Fabrication of Optical Film Sample 110)

An optical film sample 110 was fabricated in the same manner as that in the fabrication of the optical film sample 105, except that with respect to the above-fabricated optical film sample 105, the optical base material F1 was changed to the cellulose acetate film T1. In this configuration, the optically anisotropic layer was not laminated.

### (Fabrication of Optical Film Samples 111 to 119)

Optical film samples 111 to 119 were fabricated in the same manner as that in the fabrication of the optical film sample 105, except that with respect to the above-fabricated optical film sample 105, the optical base material F1 was changed to the optical base materials F2 to F10, respectively as shown in Table 1.

### (Fabrication of Optical Film Samples 120 and 121)

Optical film samples 120 and 121 were fabricated in the same manner as that in the fabrication of the optical film sample 119, except that with respect to the above-fabricated optical film sample 119, the film thickness of the hard coat layer was changed as shown in Table 1.

Various characteristics of each of the optical films were measured according to the following methods.

Incidentally, Re and Rth of the optically anisotropic layer at a wavelength of 550 nm were measured according to the foregoing methods and shown in Tables 1 and 3. Re and Rth of the whole of the optical film at a wavelength of 550 nm were measured according to the foregoing methods and shown in Tables 2 and 4.

### (Measurement of Characteristics of Optical Film)

### (1) Evaluation of Adhesion:

The surface of the optical film sample on the hard coat layer side was notched in a grid-like pattern with 11 vertical lines and 11 horizontal lines using a cutter knife, thereby forming 100 squares of 1 cm×1 cm in total. A polyester pressure-sensitive adhesive tape (No. 31B, manufactured by Nitto Denko Corporation) was attached under pressure thereonto to conduct an adhesion test, and the presence or absence of peeling off of the grid-like pattern was visually observed.

In the case where a number of the grid-like pattern peeled off was less than 20 in the 100 grid-like patterns, the adhesion test was repeated at the same place. The adhesion test was repeated two times at maximum. The presence or absence of peeling off of the grid-like pattern was visually observed, and the adhesion was evaluated according to the following criteria of five grades.

A: No peeling off was recognized at all in the 100 grid-like patterns after the adhesion test of two times.

B: Peeling off of from 1 to 5 grid-like patterns in the 100 grid-like patterns was recognized after the adhesion test of two times.

C: Peeling off of from 6 to 19 grid-like patterns in the 100 grid-like patterns was recognized after the adhesion test of two times.

D: Peeling off of 20 or more grid-like patterns in the 100 grid-like patterns was recognized after the adhesion test of two times.

E: Peeling off of 20 or more grid-like patterns in the 100 grid-like patterns was recognized after the adhesion test of one time.

### (2) Average Reflectance (Integrating Sphere Reflectance):

The back surface side of the optical film, namely, the surface on which the hard coat layer was not coated, was roughed with sand paper and then treated with a black ink, thereby forming a state of eliminating reflection on the back surface side. In the state, a spectral reflectance on the front surface side was measured in a wavelength region of from 380 to 780 nm using a spectrophotometer (manufactured by JASCO Corporation). As the result, an arithmetic average value of the integrating sphere reflectance in a range of from 450 to 650 nm was used.

### (3) Pencil Hardness:

Evaluation of pencil hardness described in JIS K5400 was conducted as an index of scratch resistance. Specifically, the optical film was subjected to humidity control at a temperature of 25° C. and a humidity of 60% RH for 2 hours; a scratching test was conducted five times on the surface of the hard coat layer side of the optical film using pencils of from 2H to 5H specified in JIS 56006 with a load of 4.9 N; the optical film was then allowed to stand under a conditions at a temperature of 25° C. and a humidity of 60% RH for 24 hours; and thereafter, the evaluation was made according to the following criteria. A highest value of the hardness which fulfilled an “OK” level was referred to as an evaluation value. The case where the pencil hardness is less than 2H is of a problematic level.

OK: Two scratches or less in the five-time evaluation.

NG: Three or more scratches in the five-time evaluation.

### (4) Light Fastness Test (Change of Retardation):

An in-plane retardation (Re) of the film after irradiating light for 50 hours in an atmosphere at a black panel temperature of 60° C. and a relative humidity of 50% under a condition at an ultraviolet ray intensity of 150 W/m² at from 300 to 400 nm from the hard coat layer side was measured using a super xenon weather meter, SX-75, manufactured by Suga Test Instruments Co., Ltd. (results are described as “Re after light fastness test” in the tables). The irradiating light included ultraviolet light of 300 nm or more and visible light.

### [Fabrication of Polarizing Plate and Image Display Device]

In order to evaluate the above-fabricated optical film upon being mounted in an image display device, the optical film was processed into a polarizing plate and evaluated in an image display device.

The surface of the above-fabricated optical film was subjected to an alkali saponification treatment. Specifically, the optical film was immersed in a 1.5 N sodium hydroxide aqueous solution at 55° C. for 2 minutes, washed in a water wash bath at room temperature, and then neutralized with 0.1 N sulfuric acid at 30° C. The film was again washed in a water wash bath at room temperature and further dried with hot air at 100° C.

Subsequently, a roll-shaped polyvinyl alcohol film having a thickness of 80 μm was continuously stretched 5 times in an iodine aqueous solution and then dried to obtain a polarizing film having a thickness of 20 μm. Each of the foregoing films having been subjected to an alkali saponification treatment and a retardation film for VA (manufactured by Fujifilm Corporation, Re/Rth at 550 nm=50/125) having been subjected to an alkali saponification treatment in a similar manner were prepared, and the polarizing film was interposed between the both films using a 3% aqueous solution of polyvinyl alcohol (PVA-117H, manufactured by Kuraray CO. Ltd.,) as an adhesive in such a manner that the surface of the optical film on the side on which the optically anisotropic layer or the hard coat layer was not laminated and an air side of the retardation film for VA at the time of film fabrication faced on the polarizing film side, thereby fabricating polarizing plate samples 101 to 121 in which each of the optical film samples 101 to 121 and the retardation film for VA functioned as protective films of the polarizing film, respectively. At that time, an angle formed by the slow axis of the optical film and the absorption axis of the polarizing film was adjusted to 45°.

### (Mounting)

TV: A polarizing plate on the viewing side of UN46C7000 (3D-TV), manufactured by Samsung was removed, and the above-fabricated retardation film for VA of the polarizing plate was stuck onto the LC cell via an adhesive, thereby fabricating a stereoscopic image display device.

LC shutter spectacles: A polarizing plate of SSG-2100AB, manufactured by Samsung (LC shutter spectacles) on the side (panel side) opposite to the viewer side was removed, and the transparent support side of the above-fabricated optical film sample 101 was stuck thereonto via an adhesive, thereby fabricating LC shutter spectacles. The slow axis of the optical film stuck onto the spectacles was adjusted in a direction orthogonal to the slow axis of the optical film included in the polarizing plate stuck onto the TV.

### (Evaluation of Display Device)

A 3D image was viewed with wearing the above-fabricated LC shutter spectacles in a room with a fluorescent lamp in an atmosphere wherein an illuminance on the panel surface was about 200 lux.

Evaluation of the image was conducted by means of sensory evaluation of stereoscopic effect of the 3D image when viewed from the front and crosstalk of the 3D image when viewed from the front or from an oblique direction according to the following criteria.

### [Stereoscopic Effect]

A: The stereoscopic effect was recognized when viewed from the front.

B: The stereoscopic effect was not recognized when viewed from the front.

### [Crosstalk]

Crosstalk (double image) was observed when viewed from the front and evaluated according to the following criteria of four grades.

A: The crosstalk was not observed at all.

B: Although the crosstalk was observed by careful view, it was enough to be ignored.

C: The crosstalk was faintly observed.

D: The crosstalk was clearly observed.

In the foregoing criteria, the grades A to C are at an acceptable level, and the grade D is at a problematic level.

The evaluation results with respect to each of the foregoing items are shown in Tables 1 and 2.

TABLE 1

| | | | | Liquid | | | | | Optically | |
|---|---|---|---|---|---|---|---|---|---|---|
| | | | | crystal | | | | | anisotropic | |
| | | Trans- | Support | of | Optical | Optically | HC | | layer | |
| | Sample | parent | Rth | anisotropic | base | anisotropic | layer | Ln | Re | Rth |
| | No. | support | (nm) | layer | material | layer | (μm) | layer | (nm) | (nm) |
| Invention | 101 | T1 | 45 | DLC-A | F1 | Yes | 3.0 | Yes | 125 | −63 |
| Comparison | 102 | T1 | 45 | DLC-A | F1 | Yes | 2.5 | Yes | 125 | −63 |
| Invention | 103 | T1 | 45 | DLC-A | F1 | Yes | 4.0 | Yes | 125 | −63 |
| Invention | 104 | T1 | 45 | DLC-A | F1 | Yes | 5.0 | Yes | 125 | −63 |
| Invention | 105 | T1 | 45 | DLC-A | F1 | Yes | 10.0 | Yes | 125 | −63 |
| Invention | 106 | T1 | 45 | DLC-A | F1 | Yes | 20.0 | Yes | 125 | −63 |
| Invention | 107 | T1 | 45 | DLC-A | F1 | Yes | 30.0 | Yes | 125 | −63 |
| Invention | 108 | T1 | 45 | DLC-A | F1 | Yes | 10.0 | No | 125 | −63 |
| Comparison | 109 | T1 | 45 | DLC-A | F1 | Yes | No | No | 125 | −63 |
| Comparison | 110 | T1 | 45 | — | T1 | No | 10.0 | Yes | — | — |
| Comparison | 111 | T1 | 45 | DLC-A | F2 | Yes | 10.0 | Yes | 70 | −35 |
| Invention | 112 | T1 | 45 | DLC-A | F3 | Yes | 10.0 | Yes | 80 | −40 |
| Invention | 113 | T1 | 45 | DLC-A | F4 | Yes | 10.0 | Yes | 100 | −50 |
| Invention | 114 | T1 | 45 | DLC-A | F5 | Yes | 10.0 | Yes | 110 | −55 |
| Invention | 115 | T1 | 45 | DLC-A | F6 | Yes | 10.0 | Yes | 160 | −80 |
| Invention | 116 | T1 | 45 | DLC-A | F7 | Yes | 10.0 | Yes | 170 | −85 |
| Invention | 117 | T1 | 45 | DLC-A | F8 | Yes | 10.0 | Yes | 200 | −100 |
| Comparison | 118 | T1 | 45 | DLC-A | F9 | Yes | 10.0 | Yes | 210 | −105 |
| Invention | 119 | T1 | 45 | RLC | F10 | Yes | 10.0 | Yes | 125 | 63 |
| Invention | 120 | T1 | 45 | RLC | F10 | Yes | 3.0 | Yes | 125 | 63 |
| Comparison | 121 | T1 | 45 | RLC | F10 | Yes | 2.5 | Yes | 125 | 63 |

TABLE 2

| | | | | | | | | | Re after |
|---|---|---|---|---|---|---|---|---|---|
| | | | | | | | | | light |
| | | | | | | Reflec- | Stereo- | Cross- | fastness |
| | Sample | Adhe- | Pencil | Re | Rth | tance | scopic | talk | test |
| | No. | sion | hardness | (nm) | (nm) | (%) | effect | at front | (nm) |
| Invention | 101 | A | 2H | 125 | −18 | 1.2 | A | A | 90 |
| Comparison | 102 | A | 2H | 125 | −18 | 1.2 | A | A | 60 |
| Invention | 103 | A | 3H | 125 | −18 | 1.2 | A | A | 110 |
| Invention | 104 | A | 3H | 125 | −18 | 1.2 | A | A | 115 |
| Invention | 105 | A | 4H | 125 | −18 | 1.2 | A | A | 120 |
| Invention | 106 | A | 5H | 125 | −18 | 1.2 | A | A | 122 |
| Invention | 107 | A | 5H | 125 | −18 | 1.2 | A | A | 123 |
| Invention | 108 | A | 4H | 125 | −18 | 4.3 | A | A | 120 |
| Comparison | 109 | * | <2H | 125 | −18 | 4.0 | A | A | 30 |
| Comparison | 110 | A | 4H | 3 | 45 | 1.1 | B | D | — |
| Comparison | 111 | A | 4H | 70 | 10 | 1.2 | B | D | 67 |
| Invention | 112 | A | 4H | 80 | 5 | 1.2 | A | C | 77 |
| Invention | 113 | A | 4H | 100 | −5 | 1.2 | A | B | 96 |
| Invention | 114 | A | 4H | 110 | −10 | 1.2 | A | A | 105 |
| Invention | 115 | A | 4H | 160 | −35 | 1.2 | A | A | 154 |
| Invention | 116 | A | 4H | 170 | −40 | 1.2 | A | B | 165 |
| Invention | 117 | A | 4H | 200 | −55 | 1.2 | A | C | 192 |
| Comparison | 118 | A | 4H | 210 | −60 | 1.2 | B | D | 202 |
| Invention | 119 | A | 4H | 125 | 108 | 1.2 | A | A | 115 |
| Invention | 120 | A | 2H | 125 | 108 | 1.2 | A | A | 85 |
| Comparison | 121 | A | 2H | 125 | 108 | 1.2 | A | A | 53 |

* : In the sample No. 109, the hard coat layer is not provided, and therefore, the adhesion test is not conducted.

The followings are apparent from the results shown in Tables 1 and 2.
1. The optical film comprising an alignment film, an optically anisotropic layer, and a hard coat layer laminated in this order in direct contact with each other on a transparent support, wherein the optically anisotropic layer is formed of a composition containing a liquid crystal compound having an unsaturated double bond, and an in-plane retardation of the optical film at a wavelength of 550 nm is from 80 to 200 nm, is suitable for a stereoscopic image display device.
2. The optically anisotropic layer according to the invention can be formed of a discotic liquid crystalline compound having an unsaturated double bond or a rod-shaped liquid crystalline compound having an unsaturated double bond.
3. The optical film comprising a hard coat layer having a thickness of 3 μm or more according to the invention is small in a change of the in-plane retardation after the light fastness test (for example, the samples Nos. 101 and 103 to 108 in comparison with the samples Nos. 102 and 109).
4. Even in the optical film in which the optically anisotropic layer is formed of a rod-shaped liquid crystalline compound having an unsaturated polymerizable group, in the case of providing a hard coat layer having a thickness of 3 μm or more, a change of the in-plane retardation after the light fastness test was small (for example, the samples Nos. 119 and 120 in comparison with the samples Nos. 109 and 121).

### Example 2

Hard coat layer forming coating solutions shown below were prepared.

### (Preparation of Coating Solution HC-2 for Hard Coat Layer)

| | |
|---|---|
| PET-30 (100%): | 59.4 g |
| BISCOAT 360 (100%): | 35.1 g |
| RUVA-93 (100%): | 1.0 g |
| IRGACURE 127 (100%): | 3.0 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-3 for Hard Coat Layer)

| | |
|---|---|
| PET-30 (100%): | 58.7 g |
| BISCOAT 360 (100%): | 34.8 g |
| RUVA-93 (100%): | 2.0 g |
| IRGACURE 127 (100%): | 3.0 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-4 for Hard Coat Layer)

| | |
|---|---|
| PET-30 (100%): | 58.1 g |
| BISCOAT 360 (100%): | 34.4 g |
| RUVA-93 (100%): | 3.0 g |
| IRGACURE 127 (100%): | 3.0 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-5 for Hard Coat Layer)

| | |
|---|---|
| PET-30 (100%): | 57.5 g |
| BISCOAT 360 (100%): | 34.0 g |
| RUVA-93 (100%): | 4.0 g |
| IRGACURE 127 (100%): | 3.2 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-6 for Hard Coat Layer)

| | |
|---|---|
| PET-30 (100%): | 56.9 g |
| BISCOAT 360 (100%): | 33.6 g |
| RUVA-93 (100%): | 5.0 g |
| IRGACURE 127 (100%): | 3.2 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-7 for Hard Coat Layer)

| | |
|---|---|
| PET-30 (100%): | 57.5 g |
| BISCOAT 360 (100%): | 34.0 g |
| RUVA-93 (100%): | 4.0 g |
| IRGACURE 819 (100%): | 3.2 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-8 for Hard Coat Layer)

| | |
|---|---|
| PET-30 (100%): | 56.9 g |
| BISCOAT 360 (100%): | 33.6 g |
| RUVA-93 (100%): | 5.0 g |
| IRGACURE 819 (100%): | 3.2 g |
| CAB polymer (20% solution): | 7.0 g |
| SP-13 (5% solution): | 2.3 g |
| MIBK: | 60.0 g |
| MEK: | 26.0 g |

### (Preparation of Coating Solution HC-9 for Hard Coat Layer)

| | |
|---|---|
| PET-30 (100%): | 58.1 g |
| BISCOAT 360 (100%): | 34.4 g |
| TINUVIN 320 (100%): | 3.0 g |
| IRGACURE 127 (100%): | 3.0 g |
| CAB polymer (20% solution): | 7.0 g |
| SP-13 (5% solution): | 2.3 g |
| MIBK: | 60.0 g |
| MEK: | 26.0 g |

Each of the foregoing coating solutions (HC-2) to (HC-9) for hard coat layer was filtered through a polypropylene-made filter having a pore size of 30 μm to prepare a coating solution. As for the foregoing coating solutions, all of refractive indices of the matrix after curing were 1.525.

The materials used are shown below.
RUVA-93: 2-[2′-Hydroxy-5′-(methacryloyloxy)ethylphenyl]-2H-benzotriazole (trade name, manufactured by Otsuka Chemical Co., Ltd.)
TINUVIN 320: 2-(3,5-Di-t-butyl-2-hydroxyphenyl)benzotriazole, manufactured by Ciba Specialty Chemicals Inc.
IRGACURE 819: Polymerization initiator whose photosensitive wavelength lies in a near ultraviolet region, manufactured by Ciba Specialty Chemicals Inc.

### (Fabrication of Optical Film Sample 201)

An optical film sample 201 was fabricated in the same manner as that in the optical film sample 105 of Example 1.

### (Fabrication of Optical Film Samples 202 to 209)

Optical film samples 202 to 209 were fabricated in the same manner as that in the optical film sample 105 of Example 1, except that with respect to the optical film sample 105, the coating solution for hard coat layer was changed from (HC-1) to (HC-2) to (HC-9), respectively.

### (Fabrication of Optical Film Samples 210 to 211)

### <Fabrication of Optical Base Material F11>

A coating solution (B) containing a discotic crystal compound having the following composition was continuously coated on the same alignment film used in the optical base material F1 by using a wire bar of #2.7. A conveying velocity of the film was adjusted to 36 m/min. The film was heated for 90 seconds with hot air at 120° C. for drying the solvent of the coating solution and alignment and ripening of the discotic liquid crystal compound. Subsequently, the film was subjected to UV irradiation at 80° C. to fix alignment of the liquid crystal compound and form an optically anisotropic layer having a thickness of 1 μm. There was thus obtained an optical base material F11.

### [Composition of Coating Solution (B) for Optically Anisotropic Layer]

| | | |
|---|---|---|
| Discotic liquid crystal compound DLC-B described below: | 100 | parts by mass |
| Photopolymerization initiator (IRGACure 907, manufactured by Ciba | 3 | parts by mass |
| Specialty Chemicals Inc.): | | |
| Sensitizer (KAYACURE DETX, manufactured by Nippon Kayaku Co., Ltd.): | 1 | part by mass |
| Pyridinium salt (2) described below: | 1 | part by mass |
| Fluorine based polymer (FP2) described below: | 0.4 | parts by mass |
| Methyl ethyl ketone: | 252 | parts by mass |

Discotic liquid crystalline compound DLC-B 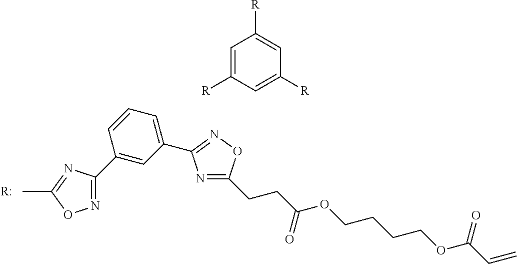
Pyridinium salt (2) 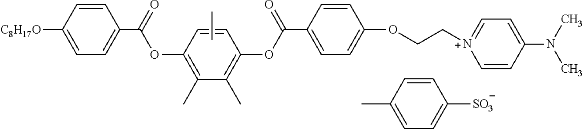
Fluorine based polymer (FP2)

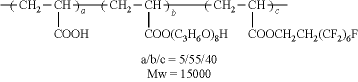

The fabricated optical base material F11 had an Re of 145 nm at 550 nm and an Nz value of 0.53. A direction of the slow axis was orthogonal to the rotation axis. That is, the slow axis was in the direction of 45° clockwise with respect to the longitudinal direction of the support. An average tilt angle of the disc plane of the discotic crystalline molecule was 90° with respect to the film plane, and it was confirmed that the discotic liquid crystal was vertically aligned with respect to the film plane.

Optical film samples 210 to 211 were fabricated in the same manner as that in the optical film samples 201 and 204, except that with respect to the optical film samples 201 and 204, the optical base material was changed from F1 to F11.

### (Fabrication of Optical Film Samples 212 to 214)

### <Fabrication of Optical Base Material F12>

A coating solution (C) containing a discotic crystal compound having the following composition was continuously coated on the same alignment film used in the optical base material F1 by using a wire bar of #2.9. A conveying velocity of the film was adjusted to 36 m/min. The film was heated for 90 seconds with hot air at 120° C. for drying the solvent of the coating solution and alignment and ripening of the discotic liquid crystal compound. Subsequently, the film was subjected to UV irradiation at 80° C. to fix alignment of the liquid crystal compound and form an optically anisotropic layer having a thickness of 1 μm. There was thus obtained an optical base material F12.

### [Composition of Coating Solution (C) for Optically Anisotropic Layer]

| | |
|---|---|
| Discotic liquid crystal compound DLC-B described | 100 parts by mass |
| above: | |
| Acrylate monomer (1) described above: | 5 parts by mass |
| Photopolymerization initiator (IRGACURE 907, | 3 parts by mass |
| manufactured by Ciba Specialty Chemicals Inc.): | |
| Sensitizer (KAYACURE DETX, manufactured by | 1 part by mass |
| Nippon Kayaku Co., Ltd.): | |
| Pyridinium salt (2) described above: | 1 part by mass |
| Fluorine based polymer (FP2) described above: | 0.4 parts by mass |
| Methyl ethyl ketone: | 252 parts by mass |

The fabricated optical base material F12 had an Re of 145 nm at 550 nm and an Nz value of 0.53. A direction of the slow axis was orthogonal to the rotation axis. That is, the slow axis was in the direction of 45° clockwise with respect to the longitudinal direction of the support. An average tilt angle of the disc plane of the discotic crystalline molecule was 90° with respect to the film plane, and it was confirmed that the discotic liquid crystal was vertically aligned with respect to the film plane.

Optical film samples 212 to 214 were fabricated in the same manner as that in the optical film samples 201, 202 and 204, except that with respect to the optical film samples 201, 202 and 204, the optical base material was changed from F1 to F12.

### (Fabrication of Optical Film Sample 215)

### <Fabrication of Optical Base Material F13>

An optical base material F13 was obtained in the same manner as that in the optical base material F1, except for using a coating solution (E) for optically anisotropic layer in which with respect to the optical base material F1, the photopolymerization initiator in the coating solution containing a discotic liquid crystal compound was changed to a phosphine oxide based polymerization initiator whose photosensitive wavelength lies in a near ultraviolet region.

### [Composition of Coating Solution (E) for Optically Anisotropic Layer]

| | |
|---|---|
| Discotic liquid crystalline compound DLC-A | 100 parts by mass |
| described above: | |
| Acrylate monomer (1) described above: | 5 parts by mass |
| Photopolymerization initiator (IRGACURE 819, | 3 parts by mass |
| manufactured by Ciba Specialty Chemicals Inc.): | |
| Sensitizer (KAYACURE DETX, manufactured | 1 part by mass |
| by Nippon Kayaku Co., Ltd.): | |
| Pyridinium salt (1) described above: | 0.5 part by mass |
| Fluorine based polymer (FP1) described above: | 0.2 parts by mass |
| Fluorine based polymer (FP3) described above: | 0.1 parts by mass |
| Methyl ethyl ketone: | 189 parts by mass |

An optical film sample 215 was fabricated in the same manner as that in optical film sample 205, except that with respect to the optical film sample 205, the optical base material was changed from F1 to F13.

### (Fabrication of Optical Film Samples 216 to 217)

Optical film samples 216 to 217 were fabricated in the same manner as that in the optical film samples 201 and 204, except that with respect to the optical film samples 201 and 204, the optical base material was changed from F1 to F10.

The measurement of various characteristics of the optical films was conducted in the same methods as those in Example 1 excluding coloration after the light fastness test.

### (Measurement of Characteristics of Optical Film)

### (5) Light Fastness Test (Coloration):

Coloration and an in-plane retardation (Re) of the film after irradiating light for 50 hours in an atmosphere at a black panel temperature of 60° C. and a relative humidity of 50% under a condition at an ultraviolet ray intensity of 150 W/m² at from 300 to 400 nm was measured using a super xenon weather meter, SX-75, manufactured by Suga Test Instruments Co., Ltd. The irradiating light included ultraviolet light of 300 nm or more and visible light.

As for the coloration after the light fastness test, the film sample before and after the light fastness test was measured for an absorbance at from 380 nm to 780 nm, and a difference from an absorbance at a wavelength of 400 nm before and after the light fastness test was defined as the coloration.

### [Fabrication of Polarizing Plate and Image Display Device]

Polarizing plates 201 to 217 in which each of the optical film samples 201 to 217 and the retardation film for VA functioned as protective films of the polarizing film, respectively were fabricated in the same manner as that in Example 1 by using the above-fabricated optical films, respectively.

In addition, stereoscopic image display devices were fabricated in the same manner as that in Example 1 by removing a polarizing plate on the viewing side of UN46C7000, manufactured by Samsung and mounting each of the above-fabricated polarizing plates 201 to 217 therein.

LC shutter spectacles were also fabricated in the same method as that in Example 1, and evaluation of the display device was conducted in the same manner as that in Example 1.

The evaluation results with respect to each of the foregoing items are shown in Tables 3 and 4.

TABLE 3

| | | | | | | | Content | | | | |
|---|---|---|---|---|---|---|---|---|---|---|---|
| | | | | | | | of UV | | | Optically | |
| | | Anisotropic layer | | | | | absorber | | | anisotropic | |
| | | Liquid | Content | Optical | | | in HC | Polymerizable | | layer | |
| | Sample | crystal | of | base | Kind of | HC layer | layer | group in UV | Ln | Re | Rth |
| | No. | compound | monomer | material | HC layer | (μm) | (%) | absorber | ayer | (nm) | (nm) |
| Invention | 201 | DLC-A | 5% | F1 | HC-1 | 10.0 | — | — | Yes | 125 | −63 |
| Invention | 202 | DLC-A | 5% | F1 | HC-2 | 10.0 | 1.0 | Yes | Yes | 125 | −63 |
| Invention | 203 | DLC-A | 5% | F1 | HC-3 | 10.0 | 2.0 | Yes | Yes | 125 | −63 |
| Invention | 204 | DLC-A | 5% | F1 | HC-4 | 10.0 | 3.0 | Yes | Yes | 125 | −63 |
| Invention | 205 | DLC-A | 5% | F1 | HC-5 | 10.0 | 4.0 | Yes | Yes | 125 | −63 |
| Invention | 206 | DLC-A | 5% | F1 | HC-6 | 10.0 | 5.0 | Yes | Yes | 125 | −63 |
| Invention | 207 | DLC-A | 5% | F1 | HC-7 | 10.0 | 4.0 | Yes | Yes | 125 | −63 |
| Invention | 208 | DLC-A | 5% | F1 | HC-8 | 10.0 | 5.0 | Yes | Yes | 125 | −63 |
| Invention | 209 | DLC-A | 5% | F1 | HC-9 | 10.0 | 3.0 | No | Yes | 125 | −63 |
| Invention | 210 | DLC-B | — | F11 | HC-1 | 10.0 | — | — | Yes | 145 | −73 |
| Invention | 211 | DLC-B | — | F11 | HC-4 | 10.0 | 3.0 | Yes | Yes | 145 | −73 |
| Invention | 212 | DLC-B | 5% | F12 | HC-1 | 10.0 | — | — | Yes | 145 | −73 |
| Invention | 213 | DLC-B | 5% | F12 | HC-2 | 10.0 | 1.0 | Yes | Yes | 145 | −73 |
| Invention | 214 | DLC-B | 5% | F12 | HC-4 | 10.0 | 3.0 | Yes | Yes | 145 | −73 |
| Invention | 215 | DLC-A | 5% | F13 | HC-5 | 10.0 | 4.0 | Yes | Yes | 125 | −63 |
| Invention | 216 | RLC | — | F10 | HC-1 | 10.0 | — | — | Yes | 125 | 63 |
| Invention | 217 | RLC | — | F10 | HC-4 | 10.0 | 3.0 | Yes | Yes | 125 | 63 |

TABLE 4

| | | | | | | | | | Re | Color- |
|---|---|---|---|---|---|---|---|---|---|---|
| | | | | | | | | | after | ation |
| | | | | | | | | | light | after |
| | | | | | | | | Cross- | fast- | light |
| | | | Pencil | | | Reflect- | Stereo- | talk | ness | fast- |
| | Sample | Adhe- | hard- | Re | Rth | ance | scopic | at | test | ness |
| | No. | sion | ness | (nm) | (nm) | (%) | effect | front | (nm) | test |
| Invention | 201 | A | 4H | 125 | −18 | 1.2 | A | A | 120 | 0.15 |
| Invention | 202 | A | 4H | 125 | −18 | 1.2 | A | A | 120 | 0.07 |
| Invention | 203 | A | 4H | 125 | −18 | 1.2 | A | A | 121 | 0.04 |
| Invention | 204 | A | 4H | 125 | −18 | 1.2 | A | A | 122 | 0.02 |
| Invention | 205 | B | 3H | 125 | −18 | 1.2 | A | A | 124 | 0.00 |
| Invention | 206 | B | 3H | 125 | −18 | 1.2 | A | A | 122 | 0.00 |
| Invention | 207 | A | 4H | 125 | −18 | 1.2 | A | A | 124 | 0.00 |
| Invention | 208 | A | 4H | 125 | −18 | 1.2 | A | A | 122 | 0.00 |
| Invention | 209 | B | 3H | 125 | −18 | 1.2 | A | A | 122 | 0.00 |
| Invention | 210 | A | 4H | 145 | −28 | 1.2 | A | A | 135 | 0.10 |
| Invention | 211 | A | 4H | 145 | −28 | 1.2 | A | A | 140 | 0.01 |
| Invention | 212 | A | 4H | 145 | −28 | 1.2 | A | A | 140 | 0.09 |
| Invention | 213 | A | 4H | 145 | −28 | 1.2 | A | A | 140 | 0.03 |
| Invention | 214 | A | 4H | 145 | −28 | 1.2 | A | A | 142 | 0.01 |
| Invention | 215 | A | 3H | 125 | −18 | 1.2 | A | A | 124 | 0.00 |
| Invention | 216 | A | 4H | 125 | 108 | 1.2 | A | A | 122 | 0.18 |
| Invention | 217 | A | 4H | 125 | 108 | 1.2 | A | A | 122 | 0.03 |

The grade B in the adhesion test in Table 4 means that the peeling-off plane was an interface between the hard coat layer and the optically anisotropic layer.

The samples after the light fastness test were observed upon being enlarged 100 times in a reflection mode of optical microscopy. As a result, only in the sample No. 209, bleeding of the ultraviolet ray absorber was observed.

The followings are apparent from the results shown in Tables 3 and 4.
1. The optical film comprising an alignment film, an optically anisotropic layer, and a hard coat layer laminated in this order in direct contact with each other on a transparent support, wherein an ultraviolet ray absorber is added to the hard coat layer, is suppressed with respect to the coloration after the light fastness test (for example, the samples Nos. 202 to 206 in comparison with the sample No. 201).

In particular, the optical film in which the amount of the ultraviolet ray absorber is from 1 to 3% by mass relative to all of the solids of the hard coat layer forming composition is very preferable because it has a high pencil hardness and is suppressed with respect to the coloration after the light fastness test (for example, the samples Nos. 202 to 204 in comparison with the samples Nos. 201, 205 and 206).
2. Even in the optical film in which the amount of the ultraviolet ray absorber is more than 3% by mass relative to all of the solids of the hard coat layer forming composition, it is possible to improve the adhesion and the pencil hardness by using a polymerization initiator whose photosensitive wavelength lies in a near ultraviolet region in the hard coat layer (for example, the samples Nos. 207 and 208 in comparison with the samples Nos. 205 and 206).
3. Not only the optical film in which an ultraviolet ray absorber having a polymerizable group is added to the hard coat layer is suppressed with respect to the coloration after the light fastness test, but it has a high pencil hardness and is suppressed with respect to bleeding of the ultraviolet ray absorber as compared with the optical film in which an ultraviolet ray absorber not having a polymerizable functional group is added to the hard coat layer (for example, the sample No. 204 in comparison with the sample No. 209).
4. The optical film in which the optically anisotropic layer is formed of a composition containing a discotic liquid crystalline compound and a polyfunctional acrylate monomer is small in the change of in-plane retardation after the light fastness test as compared with the optical film in which the optically anisotropic layer is formed of a composition not containing a polyfunctional acrylate monomer (for example, the samples Nos. 212 and 214 in comparison with the samples Nos. 210 and 211).
5. As for the optical film in which the optically anisotropic layer is formed of a discotic liquid crystalline compound, the optical film using a discotic liquid crystalline compound of a 1,3,5-substituted benzene type is small in the change of in-plane retardation after the light fastness test (for example, the samples Nos. 212 to 214 in comparison with the samples Nos. 201, 202 and 204).
6. As for the optical film in which the optically anisotropic layer is formed of a discotic liquid crystalline compound and the optical film in which the optically anisotropic layer is formed of a rod-shaped liquid crystalline compound, in the case of adding an ultraviolet ray absorber to the hard coat layer, the same effects are obtained (for example, the sample No. 217 in comparison with the sample No. 216).
7. By using a polymerization initiator of a phosphine oxide whose photosensitive length lies in a near ultraviolet region in the composition for hard coat layer containing an ultraviolet absorber, it is possible to more increase the pencil hardness and to more strengthen the adhesion (for example, the samples Nos. 207 and 208 in comparison with the samples Nos. 205 and 206).
8. By using a polymerization initiator of a phosphine oxide whose photosensitive length lies in a near ultraviolet region in the composition for optically anisotropic layer containing an ultraviolet absorber, it is possible to more strengthen the adhesion (for example, the sample No. 215 in comparison with the sample No. 205).

What is claimed is:

1. An optical film to be used as a surface film for image display device, which comprises an optically anisotropic layer and a hard coat layer in this order on one surface of a transparent support, the optically anisotropic layer and the hard coat layer being brought into direct contact with each other, wherein
the optically anisotropic layer is formed of an optically anisotropic layer forming composition containing a liquid crystalline compound having an unsaturated double bond;
the hard coat layer is formed of a hard coat layer forming composition containing a compound having an unsaturated double bond and has a film thickness of from 3 to 30 μm; and
the optical film has an in-plane retardation of from 80 to 200 nm at a wavelength of 550 nm.

2. The optical film according to claim 1,
wherein the hard coat layer forming composition further contains an ultraviolet ray absorber.

3. The optical film according to claim 2,
wherein the ultraviolet ray absorber is an ultraviolet ray absorber having an unsaturated double bond.

4. The optical film according to claim 2,
wherein a content of the ultraviolet ray absorber is from 1 to 5% by mass relative to all of the solids of the hard coat layer forming composition.

5. The optical film according to claim 1,
wherein the hard coat layer forming composition further contains a phosphine oxide based photopolymerization initiator.

6. The optical film according to claim 1,
wherein the liquid crystalline compound is a discotic liquid crystalline compound.

7. The optical film according to claim 6,
wherein the liquid crystalline compound is a discotic liquid crystal compound of a 1,3,5-substituted benzene type.

8. The optical film according to claim 1,
wherein the optically anisotropic layer forming composition further contains a non-liquid crystalline compound having an unsaturated double bond.

9. The optical film according to claim 1,
wherein a retardation of the transparent support in the thickness direction thereof at a wavelength of 550 nm is from 20 to 100 nm.

10. The optical film according to claim 1,
wherein a low refractive index layer having a refractive index lower than that of the transparent support is provided on the hard coat layer.

11. The optical film according to claim 1, which is in a long roll form in which a slow axis of the in-plane retardation is present at from 5 to 85° in the clockwise or counterclockwise direction on the basis of the length direction.

12. The optical film according to claim 1, which is used as a surface film for liquid crystal display device.

13. A polarizing plate comprising at least one protective film and a polarizing film,
wherein the at least one protective film is the optical film according to claim 1, and the surface of the optical film on the transparent support side and the polarizing film are stuck to each other.

14. An image display device comprising at least one of the optical film according to claim 1.

15. A liquid crystal display device comprising the optical film according to claim 1, a polarizing film, and a liquid crystal cell in this order from the viewing side,
wherein the optical film is disposed in such a manner that the hard coat layer is located on the viewing side, whereas the transparent support is located on the polarizing film side.
